(19) United States
(12) Patent Application Publication
(10) Pub. No.: US 2017/0082963 A1
(43) Pub. Date: Mar. 23, 2017

(54) IMAGE FORMING SYSTEM AND IMAGE FORMING METHOD

(71) Applicant: KONICA MINOLTA, INC., Tokyo (JP)

(72) Inventor: Yasushi TSUE, Tokyo (JP)

(73) Assignee: KONICA MINOLTA, INC., Tokyo (JP)

(21) Appl. No.: 15/257,284

(22) Filed: Sep. 6, 2016

(30) Foreign Application Priority Data
Sep. 18, 2015 (JP) 2015-184583

(51) Int. Cl. G03G 15/00

(52) U.S. Cl. CPC G03G 15/5062

(57) ABSTRACT

An image forming system, including: an image forming unit; a check unit; and a conveyance mechanism; wherein when an image is determined as an abnormal image, the image forming unit stops image forming and reforms the image, the conveyance mechanism includes a second conveyance path being a detour path of the first conveyance path and having a length at least equal to a length from an end point of image forming to a point of obtaining a determination result, and the conveyance mechanism conveys a sheet having an abnormal image to the second tray via the first conveyance path and conveys a sheet having a normal image to the second conveyance path for standby, and the conveyance mechanism conveys a sheet having a reformed image determined as a normal image and the sheet on the second conveyance path to the first tray in a page order.

### BACKGROUND OF THE INVENTION

1. Field of the Invention

The present invention relates to an image forming system and an image forming method.

2. Description of Related Art

Traditionally, there is known an image forming system which reads a sheet surface where an image is formed, checks whether the image is formed normally and if it is determined that the image is an abnormal image, outputs the sheet to another tray different from the tray for outputting sheets having images determined as normal images.

There is further known an image forming system including a recovery function which reforms an image of a page which is determined as an abnormal image.

In the case where an image is reformed, the sheets having images determined as normal images cannot be stacked according to the page order on a tray since the sheet of the page having image reformed is inserted somewhere between.

In view of the above, the sheets on which images are formed are temporarily stacked on a temporary storage stacker and then, the sheets are allocated and conveyed to an abnormal page stacker and a normal page stacker from the temporary storage stacker according to the check results. The sheets which are stacked on the temporary storage stacker and the sheets of the pages having images reformed and determined as normal images are conveyed according to the page order to the normal page stacker. Thus, the sheets having images determined as normal images can be stacked according to the page order. (for example, see JP 2014-184694).

However, since the sheets need to be conveyed one page by one page from the sheet bundle stacked on the temporary storage stacker, there is a possibility that multiple sheet conveyance may occur. Multiple sheet conveyance is an abnormal conveyance where two or more sheets are conveyed at the same time. If such multiple sheet conveyance occurs, a recovery operation needs to be carried out by an operator, thus degrading the productivity of image forming.

On the other hand, there is also suggested a method where a plurality of conveyance paths for standby are provided between the reading point where a sheet surface is read and the branching point to each tray. In such method, the sheets waiting to be checked are sequentially conveyed to the plurality of conveyance paths, and each sheet is made to be on standby at each conveyance path until the sheet which comes before each sheet on standby in the page order is conveyed (for example, see JP 2015-4824).

In the case where the conveyance paths for standby are provided, the same number of conveyance paths as the number of sheets which needs to be on standby until the checking of a reformed image of a page ends are needed. Since the small size sheets such as post cards require short conveyance spaces between individual pages comparing to large size sheets such as A4 size sheets, a large number of conveyance paths are needed. Thus, the size of the image forming apparatus will also be large.

### SUMMARY OF THE INVENTION

An object of the present invention is to provide a simple structure to stack the sheets having images determined as normal images after checking in the page order.

In order to achieve the above object, according to an aspect of a preferred embodiment of the present invention, there is provided an image forming system, including: an image forming unit which forms images on sheets of a plurality of pages; a check unit which determines whether an image of each page formed by the image forming unit is a normal image or an abnormal image; and a conveyance mechanism which conveys a sheet of a page having an image determined as the normal image by the check unit to a first tray via a first conveyance path and which conveys a sheet of a page having an image determined as the abnormal image by the check unit to a second tray via the first conveyance path; wherein when an image of a page is determined as the abnormal image by the check unit, the image forming unit stops image forming on a sheet of a new page and reforms the image of the page which is determined as the abnormal image, the conveyance mechanism includes a second conveyance path which is a detour path of the first conveyance path and has a length that is at least equal to a path length from a point where the image forming by the image forming unit ends to a point where a determination result of the check unit is obtained, and among pages which come after the page having the image determined as the abnormal image and have images already formed when the image is determined as the abnormal image, the conveyance mechanism conveys a sheet of a page having an image determined as the abnormal image to the second tray via the first conveyance path and conveys a sheet of each page having an image determined as the normal image to the second conveyance path so as to be on standby, and the conveyance mechanism conveys a sheet of a page having a reformed image determined as the normal image and the sheet of each page on the second conveyance path to the first tray in a page order.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a front view of an image forming system according to an embodiment of the present invention;

FIG. 2 is a block diagram showing the main structure of the image forming system shown in FIG. 1 in terms of individual functions;

FIG. 3A shows a conveyance flow of sheets in the case where images formed on sheets are continuously determined as abnormal images;

FIG. 3B shows the conveyance flow of sheets in the case where images formed on sheets are continuously determined as abnormal images;

FIG. 3C shows the conveyance flow of sheets in the case where images formed on sheets are continuously determined as abnormal images;

FIG. 3D shows the conveyance flow of sheets in the case where images formed on sheets are continuously determined as abnormal images;

FIG. 3E shows the conveyance flow of sheets in the case where images formed on sheets are continuously determined as abnormal images;

FIG. 3F shows the conveyance flow of sheets in the case where images formed on sheets are continuously determined as abnormal images;

FIG. 3G shows the conveyance flow of sheets in the case where images formed on sheets are continuously determined as abnormal images;

FIG. 3H shows the conveyance flow of sheets in the case where images formed on sheets are continuously determined as abnormal images;

FIG. 3I shows the conveyance flow of sheets in the case where images formed on sheets are continuously determined as abnormal images;

FIG. 3J shows the conveyance flow of sheets in the case where images formed on sheets are continuously determined as abnormal images;

FIG. 3K shows the conveyance flow of sheets in the case where images formed on sheets are continuously determined as abnormal images;

FIG. 3L shows the conveyance flow of sheets in the case where images formed on sheets are continuously determined as abnormal images;

FIG. 3M shows the conveyance flow of sheets in the case where images formed on sheets are continuously determined as abnormal images;

FIG. 4A shows a conveyance flow of sheets in the case where a reformed image is determined as an abnormal image;

FIG. 4B shows the conveyance flow of sheets in the case where a reformed image is determined as an abnormal image;

FIG. 4C shows the conveyance flow of sheets in the case where a reformed image is determined as an abnormal image;

FIG. 4D shows the conveyance flow of sheets in the case where a reformed image is determined as an abnormal image;

FIG. 4E shows the conveyance flow of sheets in the case where a reformed image is determined as an abnormal image;

FIG. 4F shows the conveyance flow of sheets in the case where a reformed image is determined as an abnormal image;

FIG. 4G shows the conveyance flow of sheets in the case where a reformed image is determined as an abnormal image;

FIG. 4H shows the conveyance flow of sheets in the case where a reformed image is determined as an abnormal image;

FIG. 5A shows a conveyance flow of sheets in the case where images formed on sheets are intermittently determined as abnormal images;

FIG. 5B shows the conveyance flow of sheets in the case where images formed on sheets are intermittently determined as abnormal images;

FIG. 5C shows the conveyance flow of sheets in the case where images formed on sheets are intermittently determined as abnormal images;

FIG. 5D shows the conveyance flow of sheets in the case where images formed on sheets are intermittently determined as abnormal images;

FIG. 5E shows the conveyance flow of sheets in the case where images formed on sheets are intermittently determined as abnormal images;

FIG. 5F shows the conveyance flow of sheets in the case where images formed on sheets are intermittently determined as abnormal images;

FIG. 5G shows the conveyance flow of sheets in the case where images formed on sheets are intermittently determined as abnormal images;

FIG. 5H shows the conveyance flow of sheets in the case where images formed on sheets are intermittently determined as abnormal images;

FIG. 5I shows the conveyance flow of sheets in the case where images formed on sheets are intermittently determined as abnormal images;

FIG. 5J shows the conveyance flow of sheets in the case where images formed on sheets are intermittently determined as abnormal images;

FIG. 5K shows the conveyance flow of sheets in the case where images formed on sheets are intermittently determined as abnormal images;

FIG. 5L shows the conveyance flow of sheets in the case where images formed on sheets are intermittently determined as abnormal images;

FIG. 6A shows a conveyance flow of sheets in the case where a reformed image is determined as an abnormal image;

FIG. 6B shows the conveyance flow of sheets in the case where a reformed image is determined as an abnormal image;

FIG. 6C shows the conveyance flow of sheets in the case where a reformed image is determined as an abnormal image;

FIG. 6D shows the conveyance flow of sheets in the case where a reformed image is determined as an abnormal image;

FIG. 6E shows the conveyance flow of sheets in the case where a reformed image is determined as an abnormal image;

FIG. 6F shows the conveyance flow of sheets in the case where a reformed image is determined as an abnormal image;

FIG. 6G shows the conveyance flow of sheets in the case where a reformed image is determined as an abnormal image;

FIG. 6H shows the conveyance flow of sheets in the case where a reformed image is determined as an abnormal image;

FIG. 6I shows the conveyance flow of sheets in the case where a reformed image is determined as an abnormal image;

FIG. 7A shows a conveyance flow of sheets in different sizes in the case where images formed on sheets are intermittently determined as abnormal images;

FIG. 7B shows the conveyance flow of sheets in different sizes in the case where images formed on sheets are intermittently determined as abnormal images;

FIG. 7C shows the conveyance flow of sheets in different sizes in the case where images formed on sheets are intermittently determined as abnormal images;

FIG. 7D shows the conveyance flow of sheets in different sizes in the case where images formed on sheets are intermittently determined as abnormal images;

FIG. 7E shows the conveyance flow of sheets in different sizes in the case where images formed on sheets are intermittently determined as abnormal images;

FIG. 7F shows the conveyance flow of sheets in different sizes in the case where images formed on sheets are intermittently determined as abnormal images;

FIG. 8A shows a conveyance flow of sheets in the case where a reformed image is determined as an abnormal image;

FIG. 8B shows the conveyance flow of sheets in the case where a reformed image is determined as an abnormal image;

FIG. 8C shows the conveyance flow of sheets in the case where a reformed image is determined as an abnormal image;

FIG. 8D shows the conveyance flow of sheets in the case where a reformed image is determined as an abnormal image;

FIG. 9 is a flowchart showing a process procedure carried out in the image forming system when forming an image; and

FIG. 10 is a flowchart showing a process procedure carried out in the image forming system when conveying a sheet after image forming is carried out thereon.

### DETAILED DESCRIPTION OF THE PREFERRED EMBODIMENT

Hereinafter, embodiments of the image forming system and the image forming method according to the present invention will be described with reference to the drawings.

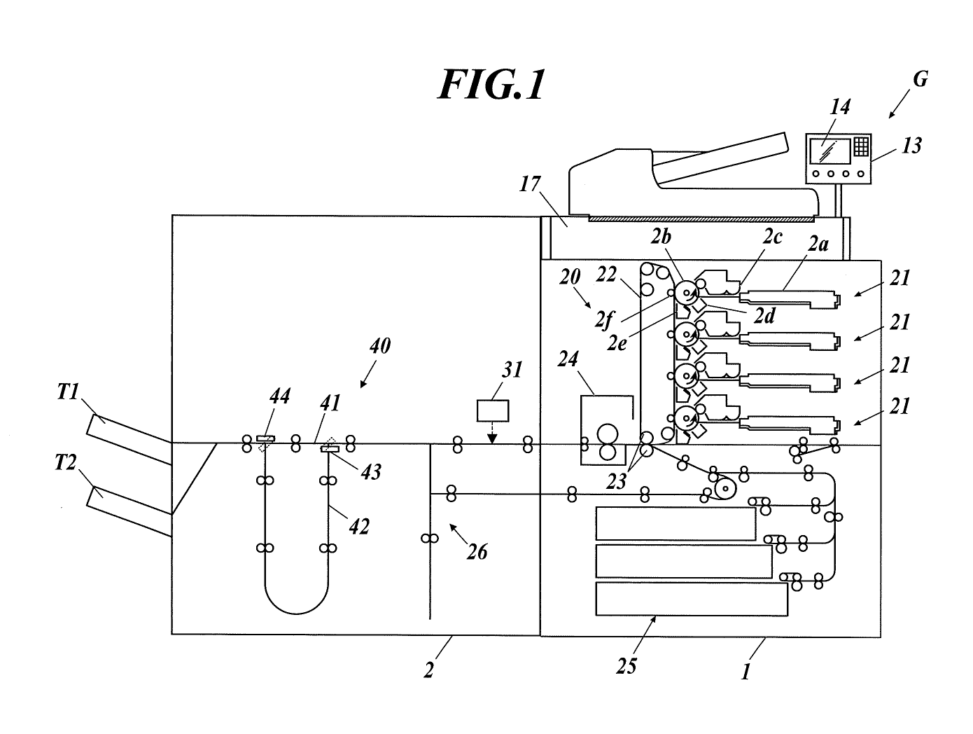

FIG. 1 shows an image forming system G according to an embodiment of the present invention.

As shown in FIG. 1, the image forming system G includes a unit 1 in which images are formed on sheets of a plurality of pages on the basis of original image data and a unit 2 in which whether the image of each page formed in the unit 1 is a normal image or an abnormal image is determined.

The unit 2 includes the first tray T1 on which sheets having images determined as normal images are to be stacked and the second tray T2 on which sheets having images determined as abnormal images are to be stacked.

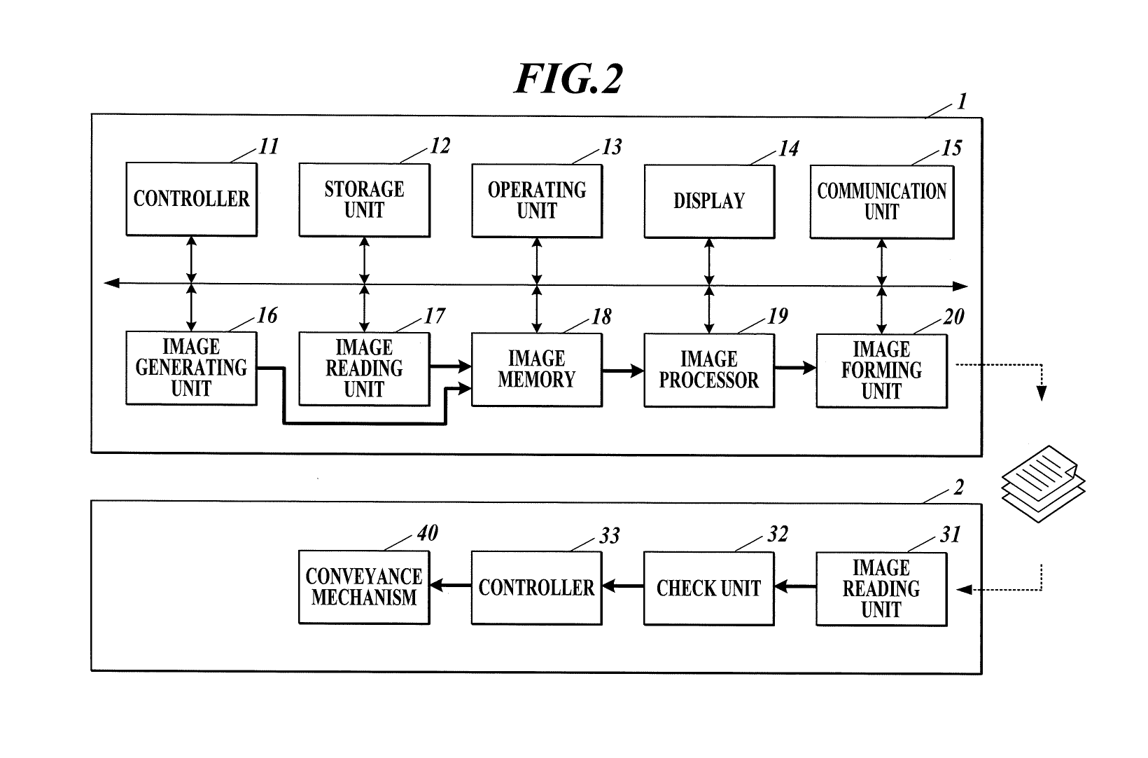

FIG. 2 is a block image showing the main structure of the units 1 and 2 in terms of individual functions.

As shown in FIG. 2, the unit 1 includes a controller 11, a storage unit 12, an operating unit 13, a display 14, a communication unit 15, an image generating unit 16, an image reading unit 17, an image memory 18, an image processor 19 and an image forming unit 20.

The controller 11 is formed by including a CPU (Central Processing Unit), a RAM (Random Access Memory) and the like. The controller 11 carries out various types of processes by reading out various types of programs from the storage unit 12 and executing the programs.

For example, the controller 11 makes the image processor 19 perform an image process on original image data which is generated by the image generating unit 16 or the image reading unit 17 and stored in the image memory 18, and makes the image forming unit 20 form an image on a sheet on the basis of the processed original image data.

In the storage unit 12, programs which can be read by the controller 11, files which are used when executing the programs and the like are stored. A large capacity memory such as a hard disk or the like can be used as the storage unit 12.

As shown in FIG. 1, the operating unit 13 and the display 14 are provided at the upper part of the unit 1 as a user interface.

The operating unit 13 generates operation signals according to operations performed by a user and outputs the operation signals to the controller 11. As for the operating unit 13, a key pad, a touch panel which is formed integrally with the display 14 or the like can be used.

The display 14 displays an operation screen and the like in accordance with the controller 11's instruction. As for the display 14, a LCD (Liquid Crystal Display), an OELD (Organic Electro Luminescence Display) or the like can be used.

The communication unit 15 communicates with an external device on a network such as a user terminal, a server, other image forming system and the like, for example.

The communication unit 15 receives data (hereinafter, called PDL data) in which an instruction content for image forming is written in a page description language (PDL) from a user terminal via the network.

The image generating unit 16 carries out a rasterizing process on the PDL data which is received by the communication unit 15 and generates original image data of the bitmap format including the density values of each pixel. With respect to the original image data, each pixel includes density values of four colors which are C (cyan), M (magenta), Y (yellow) and K (black). Density value is a data value which expresses the contrasting density of an image and for example, the data value of 8 bits expresses the contrasting density of 0 to 255 levels.

The image reading unit 17 is formed by including an automatic sheet feeder, a scanner and the like as shown in FIG. 1. The image reading unit 17 reads the document surface which is set on the document platform and generates original image data of the bitmap format. With respect to the original image data generated by the image reading unit 17, each pixel has density values of three colors which are R (red), G (green) and B (blue). Such original image data is color converted into image data having density values of four colors which are C, M, Y and K by the color converter (not shown in the drawing).

The image memory 18 is a buffer memory in which the original image data which is generated by the image generating unit 16 or the image reading unit 17 is temporarily stored. As for the image memory 18, a DRAM (Dynamic RAM) or the like can be used.

The image processor 19 reads out the original image data from the image memory 18 and carries out image processes such as a density correction process, a halftone process and the like on the original image data.

The density correction process is a process to convert the density values of each pixel in the original image data into the corrected density values so that the density of the image formed on a sheet matches the target density.

The halftone process is a process for reproducing a pseudo halftone, and is a screen process and the like using an error diffusion process or an ordered dither method, for example.

The image forming unit 20 forms an image of four colors which are C, M, Y and K on a sheet in accordance with the density values of each pixel in the original image data, the image process being carried out on the original image data by the image processor 19.

As shown in FIG. 1, the image forming unit 20 includes four writing units 21, an intermediate transfer belt 22, secondary transfer rollers 23, a fixing device 24 and sheet feeding trays 25.

The four writing units 21 are disposed in tandem along the belt surface of the intermediate transfer belt 22 and forms images of colors of C, M, Y and K. The writing units 21 have the same structure, and the only difference is that the color of the image each writing unit 21 forms is different. As shown in FIG. 1, each of the writing unit 21 includes an optical scanner 2a, a photoreceptor 2b, a developing unit 2c, a charger 2d, a cleaner 2e and a primary transfer roller 2f.

At the time of image forming, in each writing unit 21, the photoreceptor 2b is charged by the charger 2d, the photoreceptor 2b is scanned by the bundle of rays which is emitted by the optical scanner 2a and an electrostatic latent image is formed on the basis of the original image data. After the developing unit 2c supplies color materials such as toner and the like and performs developing, an image is formed on the photoreceptor 2b.

The images which are formed on the individual photoreceptors 2b of the four writing units 21 are superimposed on each other in an order and transferred on the intermediate transfer roller 22 by the individual primary transfer rollers 2f (primary transfer). In such way, an image formed of individual colors is formed on the intermediate transfer belt 22. After the primary transfer, the cleaners 2e remove the residual color materials on the photoreceptors 2b.

In the image forming unit 20, sheets are fed by the sheet feeding trays 25 at the timing when the image on the rotating intermediate transfer belt 22 reaches the position of the secondary transfer rollers 23, and the image is transferred (secondary transfer) on to a sheet from the intermediate transfer belt 22 by the secondary transfer rollers 23. After the secondary transfer, the sheet is heated and pressed by the fixing device 24 so that the image is fixed to the sheet. In the case where images are to be formed on both sides of a sheet, the sheet is conveyed to the conveyance path 26 and the sheet surface is reversed and then, the sheet is fed again to the position of the secondary transfer rollers 23.

If it is determined that an image of any one page is an abnormal image in the unit 2, the image forming unit 20 stops the image forming on a new page and reforms the image of the page which is determined as an abnormal image. The image forming unit 20 repeats reforming of images until all of the images of the pages which are determined as abnormal images among the images of the pages which are already formed by the time when an image of a page is determined as abnormal are determined as normal images.

If the images of all of the pages which are determined as abnormal images are reformed and they are now determined as normal images in the unit 2, the image forming unit 20 restarts the image forming on a new page.

As shown in FIG. 2, the unit 2 includes an image reading unit 31, a check unit 32, a controller 33 and a conveyance mechanism 40.

The image reading unit 31 is disposed on the sheet conveyance path which is the conveyance path where the sheets are conveyed after the image forming is performed thereon as shown in FIG. 1. The reading unit 31 reads the sheet surfaces on which images are formed by the image forming unit 20 and generates read image data of the bitmap format.

As for the image reading unit 31, a line sensor, an area sensor and the like using an image pickup device such as a CCD (Charge Coupled Device) can be used.

The check unit 32 uses the read image data which is generated by the image reading unit 31 to determine whether the images formed on the sheets are normal images or abnormal images.

The determining method is not limited and for example, the read image data and the original image data may be compared for differences in their density values, and if the number of pixels having density value differences exceeding the threshold is more than a certain number, the image is determined as an abnormal image, and if the number of such pixels is equal to or smaller than the certain number, the image is determined as a normal image. Further, feature points may be detected in the read image data and the original image data to calculate the feature amounts, and if the difference in the feature amounts between the read image data and the original image data exceeds the threshold, the image is determined as an abnormal image, and if the difference in the feature amounts between the read image data and the original image data is equal to the threshold or is smaller than the threshold, the image is determined as a normal image.

The controller 33 controls the sheet conveyance by the conveyance mechanism 40 according to the check results of the check unit 32.

The conveyance mechanism 40 conveys the sheets on which images are formed in the unit 1 to the first tray T1 or the second tray T2.

As shown in FIG. 1, the conveyance mechanism 40 includes the first conveyance path 41 which guides the sheets to the first tray T1 or the second tray T2 after the image forming and the second conveyance path 42 which is the detour path of the first conveyance path 41. The path length of the second conveyance path 42 is adjusted so as to be at least the same length as the path length between the point where the image forming by the image forming unit 20 ends and the point where the determination result of the check unit 32 is obtained.

The conveyance mechanism 40 further includes sheet guides 43 and 44. In the conveyance mechanism 40, a sheet on the first conveyance path 41 is made to make a detour to the second conveyance path 42 by the sheet guide 43 and the sheet which is made to make a detour to the second conveyance path 42 is made to return to the first conveyance path 41 by the sheet guide 44.

It is preferable that the second conveyance path 42 is a circulation path since the conveyance mechanism 40 can convey a sheet on the second conveyance path 42 so as to circulate.

In accordance with the conveyance controlling of the controller 33, the conveyance mechanism 40 conveys sheets of pages having images determined as normal images by the check unit 32 to the first tray T1 via the first conveyance path 41 and conveys sheets of pages having images determined as abnormal images by the check unit 32 to the second tray T2 via the first conveyance path 41.

If an image of any one page is determined as an abnormal image, among the pages which come after the one page having image determined as an abnormal image and the pages having images already formed by the time the image of the one page is determined as an abnormal image, the conveyance mechanism 40 conveys the sheets of the pages having images determined as abnormal images to the second tray T2 via the first conveyance path 41 and conveys the sheets of the pages having images are determined as normal images to the second conveyance path 42 and make the sheets be on standby. The conveyance mechanism 40 conveys the sheets of the pages having images determined as abnormal images and thereafter having reformed images determined as normal images and the sheets of the pages on the second conveyance path 42 to the first tray T1 in the page order.

In the above described image forming system G, the images of the pages which are determined as abnormal images as the result of checking are reformed, and the sheets of the pages having images determined as normal images can be stacked in the page order on another tray different from the tray for stacking the sheets of the pages having images determined as abnormal images.

Hereinafter, image forming examples for stacking the sheets of the pages having images determined as normal images in the page order in the above described image forming system G will be described.

### IMAGE FORMING EXAMPLE 1

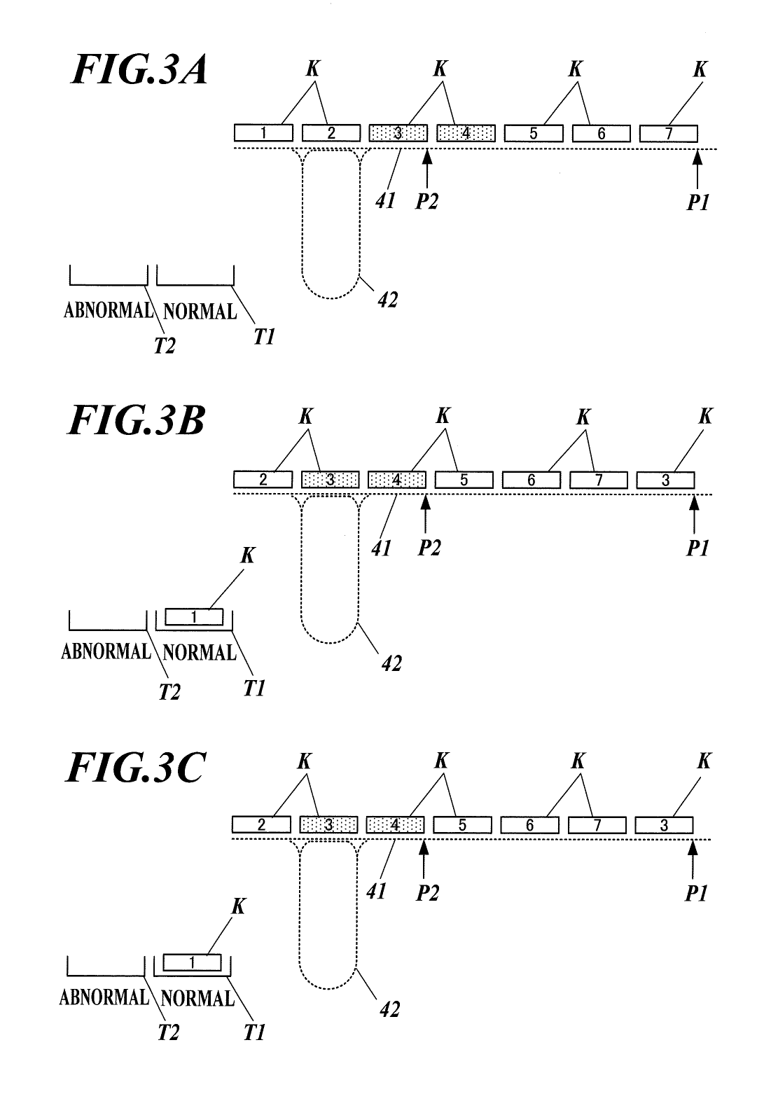

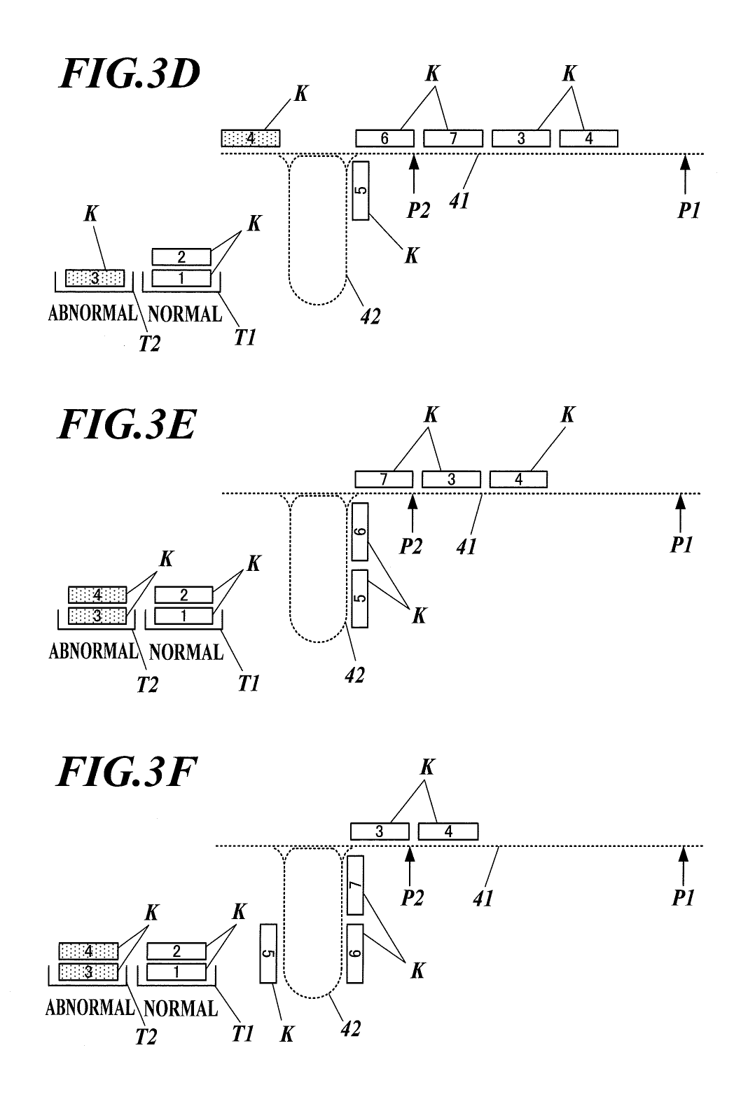

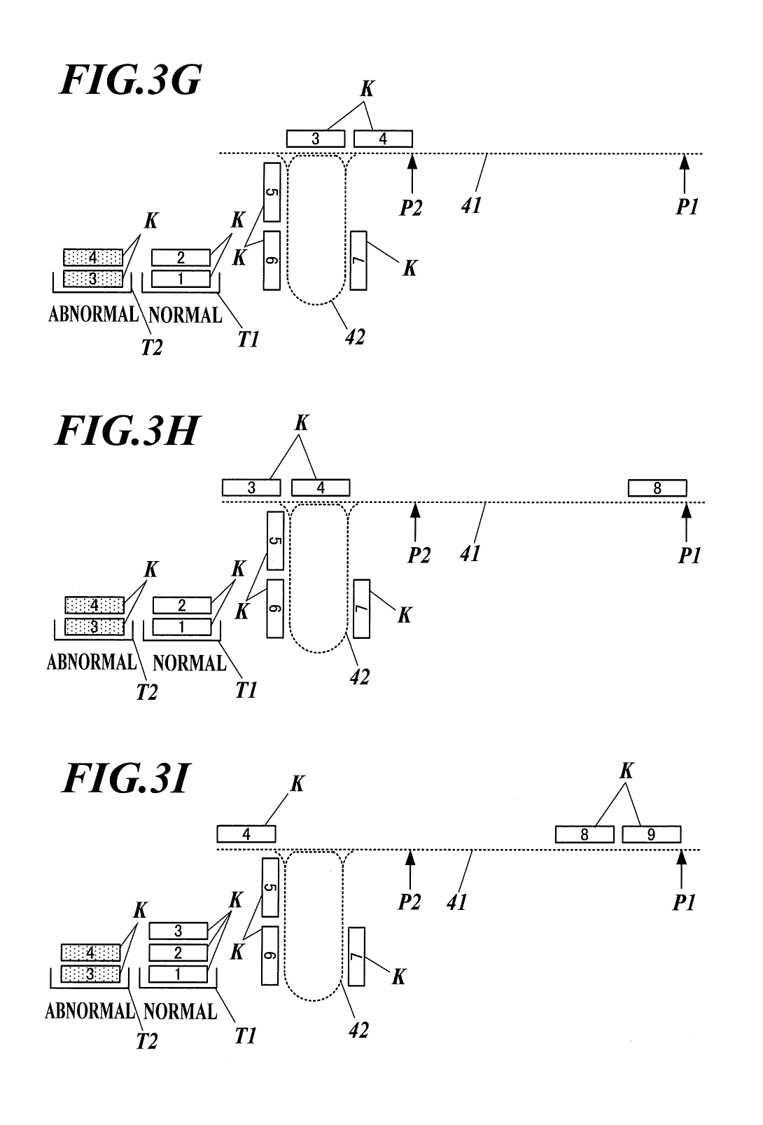

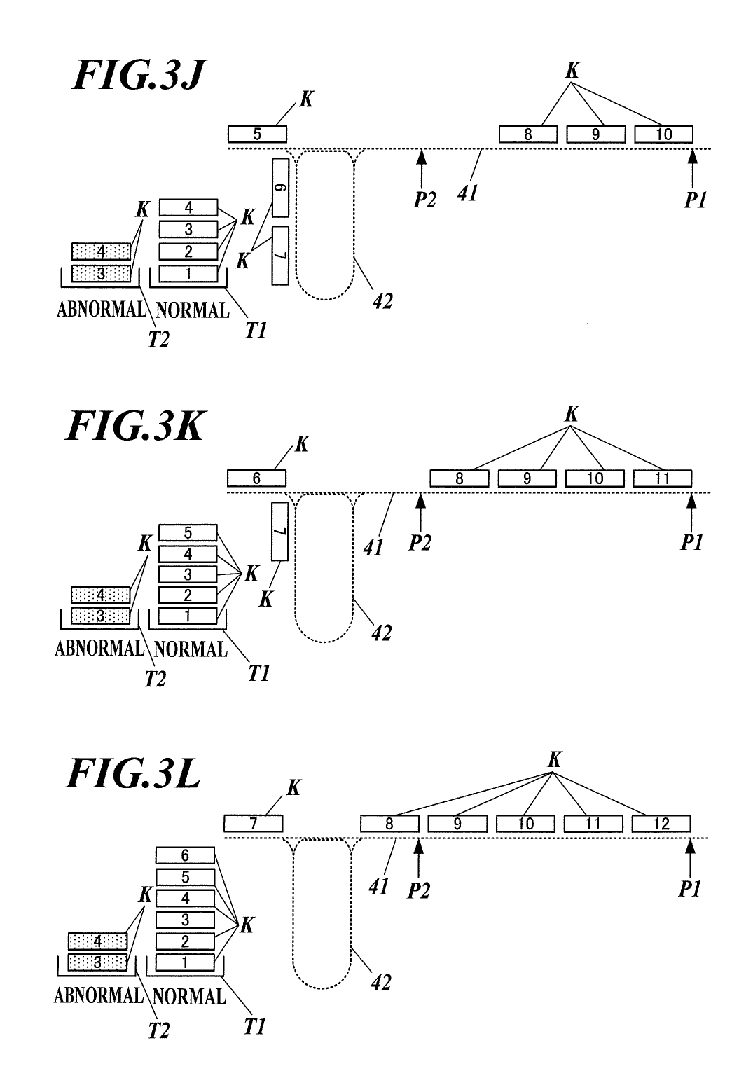

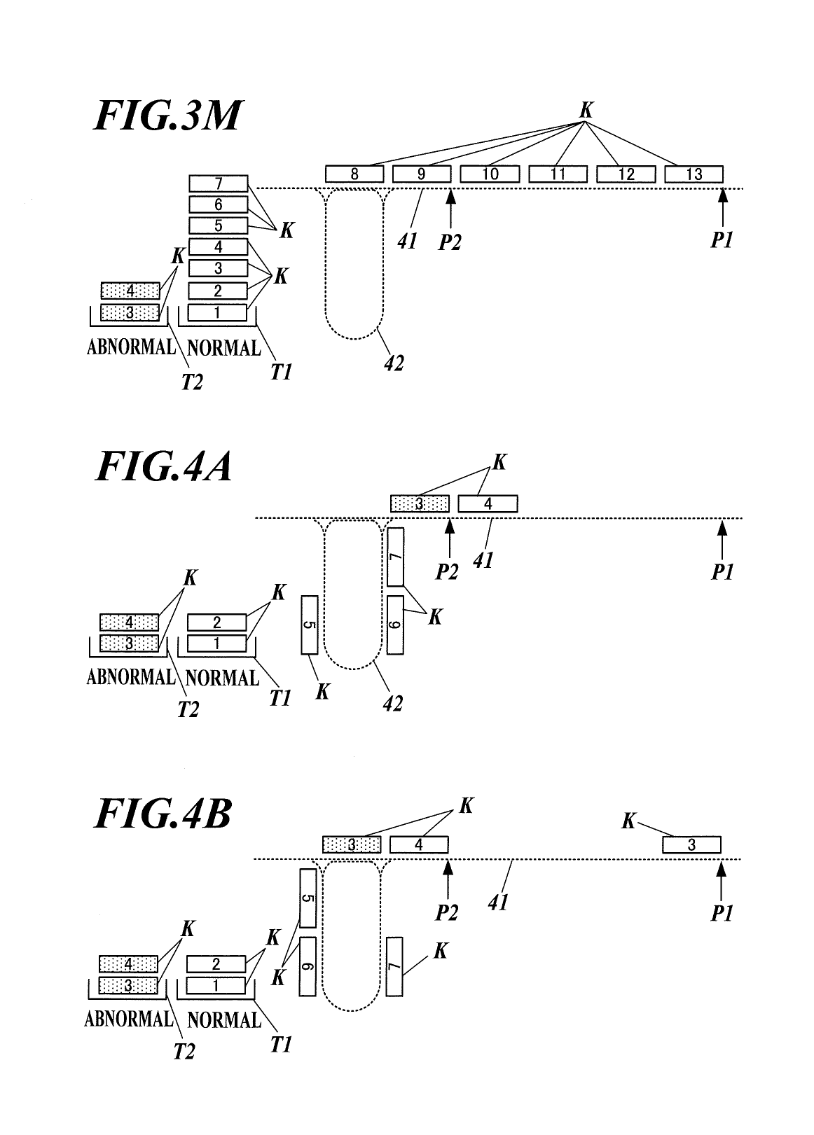

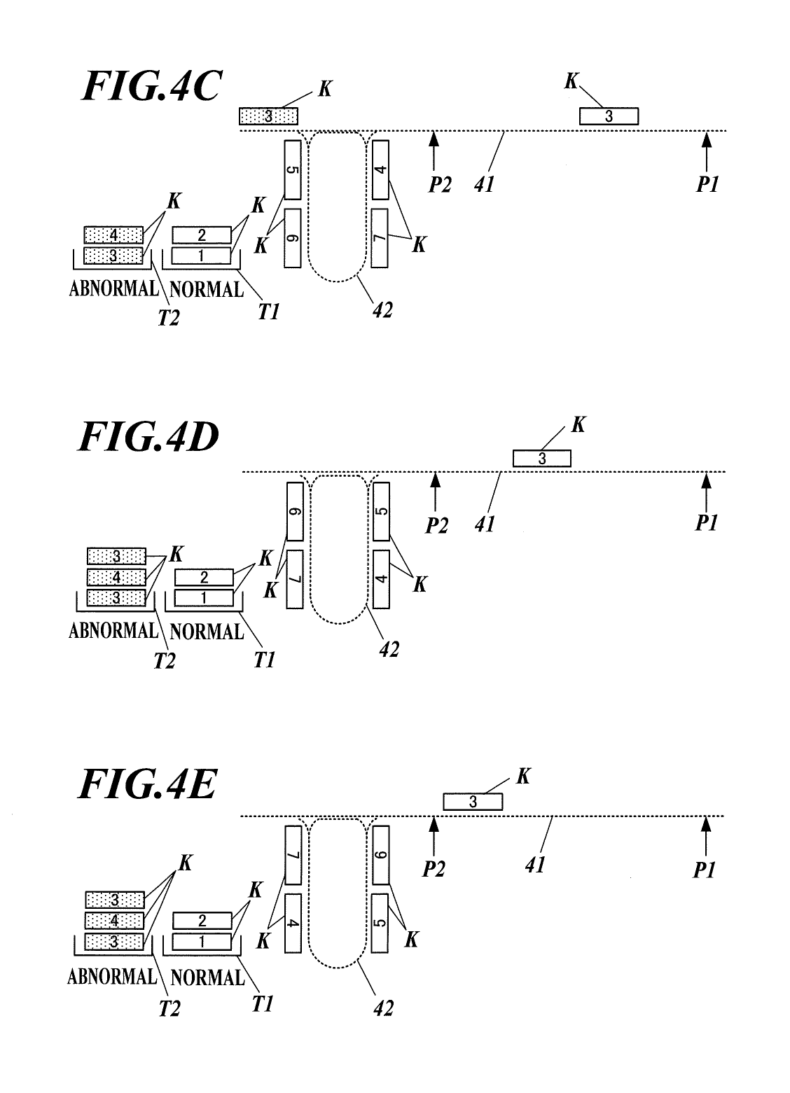

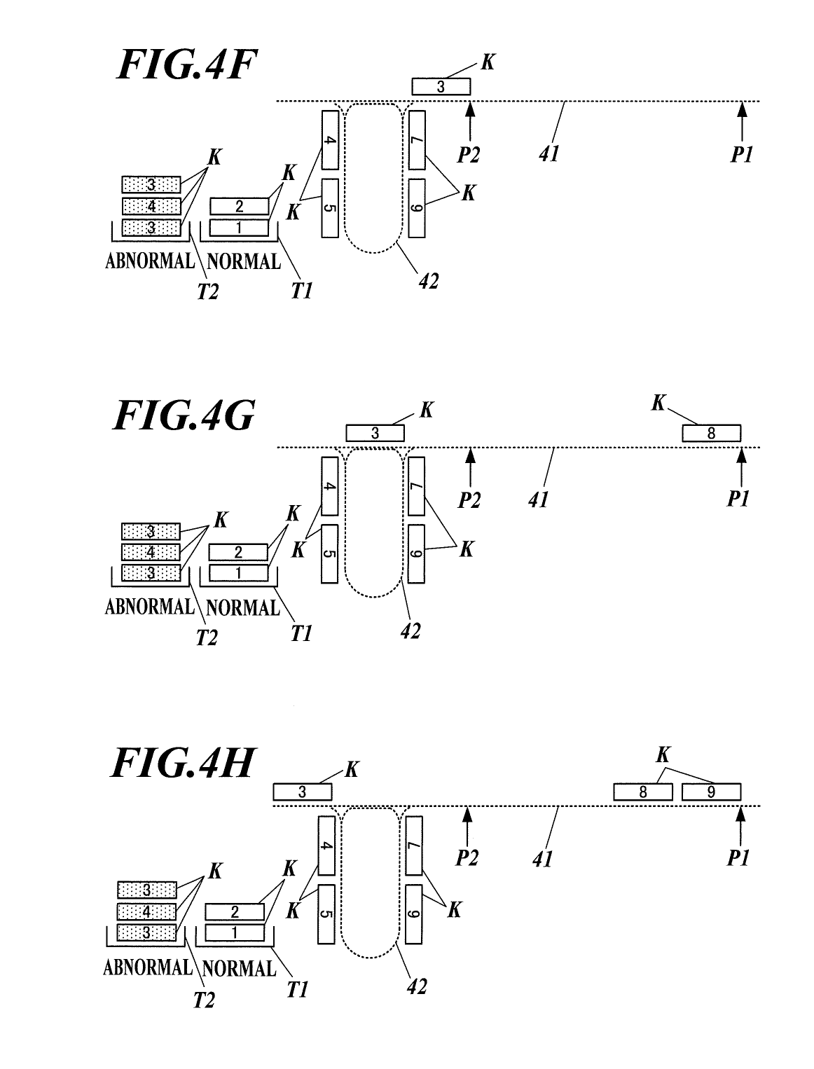

FIGS. 3A to 3M and FIGS. 4A to 4H show, in chronological order, the sheet conveyance flow in the unit 2 in the case where the images of the third and the fourth pages are continuously determined as abnormal images.

In FIGS. 3A to 3M and FIGS. 4A to 4H, the numbers used for the individual sheets K indicate the page order. Further, the sheets K with dot pattern are the pages having images determined as abnormal images.

As shown in FIG. 3A, the length of the first conveyance path 41 from the point P1 where the image forming by the image forming unit 20 ends to the first tray T1 or the second tray T2 is equal to the path length on which seven pages of sheets K can be conveyed.

Further, the length of the first conveyance path 41 from the point P1 where the image forming ends to the point P2 where the check result of the check unit 32 is obtained is equal to the path length on which four pages of sheets K can be conveyed. The length of the second conveyance path 42 is longer than the path length between the points P1 and P2.

The point P1 where the image forming ends is, in particular, the position where the fixing process ends. The point P2 where the check result is obtained is the position where a check result can be obtained for sure regardless of the size of the sheets K, how complicated the image is and the like. The length of the conveyance path between the points P1 and P2 is adjusted taking the size of the sheets K and how complicated the image is and the like into consideration so that the check result can be obtained at the point P2 for sure. Here, the point P2 is the last point where the check result can be obtained, and there may be cases where the check results can be obtained before reaching the point P2.

Images are formed in an order starting from the first page and if, at the point P2 in the unit 2, the images of the first and second pages are determined as normal images as shown in FIG. 3A, the sheets K of the first and second pages are output to the first tray T1 as shown in FIGS. 3B and 3C.

If the image of the third page is determined as an abnormal image, the sheet K of the third page having image determined as an abnormal image is output to the second tray T2 via the first conveyance path 41 in the unit 2 as shown in FIGS. 3B, 3C and 3D.

At the time when the image of the third page is determined as an abnormal image, the image forming on a new page is stopped in the unit 1. As shown in FIG. 3A, at the time when the sheet K of the third page passes the point P2 and when the image of the third page is determined as an abnormal image, images are already formed on the sheets K of the fourth to the seventh pages. In the unit 1, the image forming on a new page which is the eighth page is stopped and the image of the third page is reformed as shown in FIG. 3B.

If the image of the fourth page is also determined as an abnormal image continuously to the image of the third page as shown in FIG. 3B, the sheet K of the fourth page is output to the second tray T2 via the first conveyance path 41 in the unit 2 as shown in FIGS. 3C, 3D and 3E. In the unit 1, the image of the fourth page is reformed as shown in FIG. 3C.

If the image of the fifth page is determined as a normal image at the point P2 as shown in FIG. 3C, the sheet K of the fifth page is conveyed to the second conveyance path 42 in the unit 2 as shown in FIG. 3D. Similarly, in the unit 2, the sheets K of the sixth and seventh pages having images determined as normal images are sequentially conveyed to the second conveyance path 42 as shown in FIGS. 3E and 3F.

If the images of the third and fourth pages, which are reformed after the image of the seventh page is formed, are determined as normal images as shown in FIGS. 3F and 3G, the sheets K of the third and fourth pages on which the images are reformed are sequentially output to the first tray T1 via the first conveyance path 41 in the unit 2 as shown in FIGS. 3H, 3I and 3J. Until the sheet K of the fourth page which is the last page on which the image is reformed is output, the sheets K of the fifth to seventh pages which are conveyed to the second conveyance path 42 are made to be on standby on the second conveyance path 42.

After the sheet K of the fourth page which is the last page on which the image is reformed is output, the sheets K of the fifth to seventh pages on the second conveyance path 42 are output to the first tray T1 in the page order in the unit 2 as shown in FIGS. 3J, 3K, 3L and 3M.

At the time when the reformed image of the fourth page, which is the last page on which the image is reformed, is determined as a normal image, the image forming on a new page is restarted in the unit 1 and the image of the eighth page is formed as shown in FIG. 3H.

If the images of the eight page and all of the pages thereafter are determined as normal images, the sheets K of the pages are sequentially output to the first tray T1 via the first conveyance path 41 in the unit 2 as shown in FIG. 3M.

In the above described conveyance flow, if the reformed image of the third page, which is reformed after the image of the seventh page is formed, is determined as an abnormal image, the conveyance flow shown in FIG. 3F and thereafter will be replaced by the conveyance flow shown in FIGS. 4A to 4H.

If the reformed image of the third page is determined as an abnormal image as shown in FIG. 4A, the sheet of the third page on which the image is reformed is output to the second tray T2 via the first conveyance path 41 in the unit 2 as shown in FIGS. 4B, 4C and 4D. In the unit 1, the image of the third page is reformed as shown in FIG. 4B.

If the reformed image of the fourth page is determined as a normal image as shown in FIG. 4B, the sheet of the fourth page on which the image is reformed is conveyed to the second conveyance path 42 in the unit 2 as shown in FIG. 4C.

Thereafter, until the check result of the reformed image of the third page is obtained, the sheets K of the fourth to seventh pages on the second conveyance path 42 are made to be on standby by circulating in the second conveyance path 42 in the unit 2 as shown in FIGS. 4C, 4D and 4E. When conveying the sheets of the fourth to seventh pages from the second conveyance path 42, the sheets are to be conveyed in the page order, thus, the circulation may be stopped when the fourth page, which comes first in the page order among the sheets on the second conveyance path 42, is at the exit position of the second conveyance path 42.

If the reformed image of the third page is determined as a normal image as shown in FIG. 4F, the sheet of the third page on which the image is reformed is output to the first tray T1 via the first conveyance path 41 in the unit 2 as shown in FIGS. 4G and 4H.

As shown in FIGS. 4G and 4H, the image forming on new pages which are the eighth page and the pages thereafter is restarted in the unit 1 at the time when the reformed image of the third page, which is the last page having image reformed, is determined as a normal image.

In the unit 2, the sheets K of the fourth to seventh pages on the second conveyance path 42 are output to the first tray T1 in the page order. Thereafter, if the images of the eighth page and the pages thereafter are determined as normal images, the sheets K of the eighth page and the pages thereafter are output to the first tray T1 via the first conveyance path 41 in the unit 2 as shown in FIGS. 3L and 3M.

By stopping the image forming on a new page and starting to reform the image of the page which is determined as an abnormal image at the time when the image is determined as an abnormal image, and by making the sheets of the pages having images determined as normal images that come after the page having image determined as an abnormal image be on standby on the second conveyance path until the reformed image is determined as a normal image and output to the first tray T1, the sheets of the pages having images determined as normal images can be stacked in the page order. Since the length of the second conveyance path 42 is at least equal to the path length between the points P1 and P2, all of the sheets of the pages that come after the page having image determined as an abnormal image can be held on the second conveyance path 42.

### IMAGE FORMING EXAMPLE 2

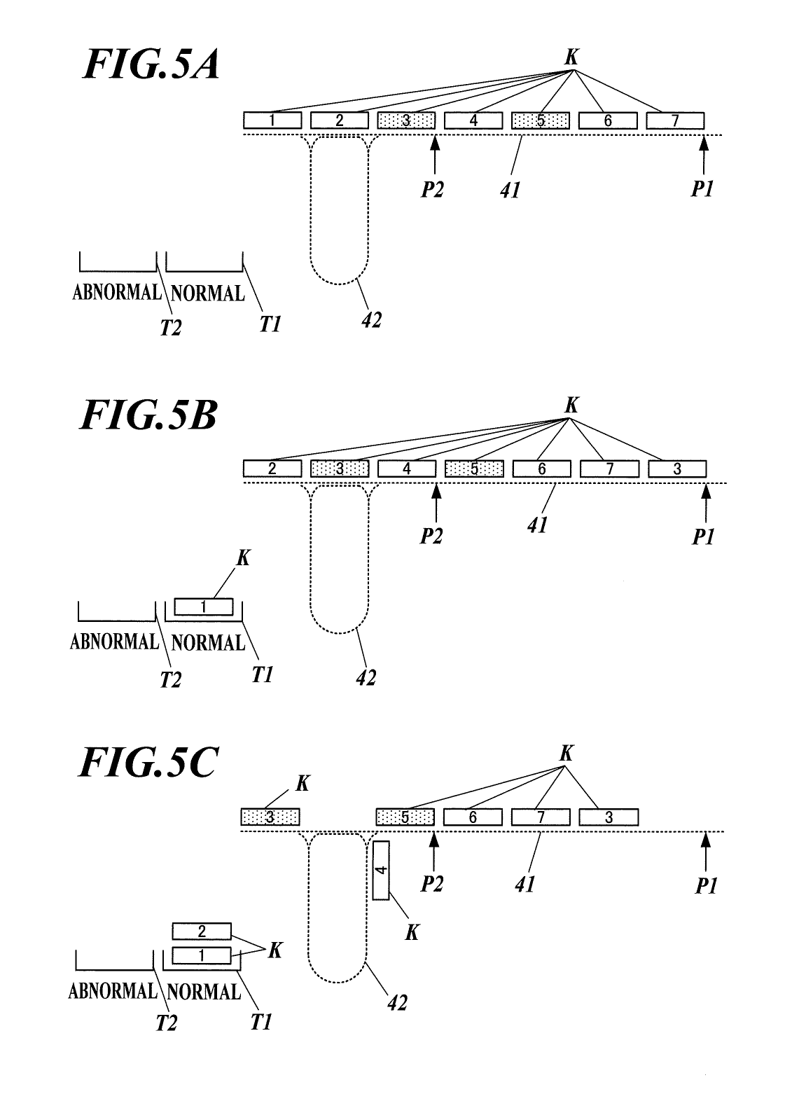

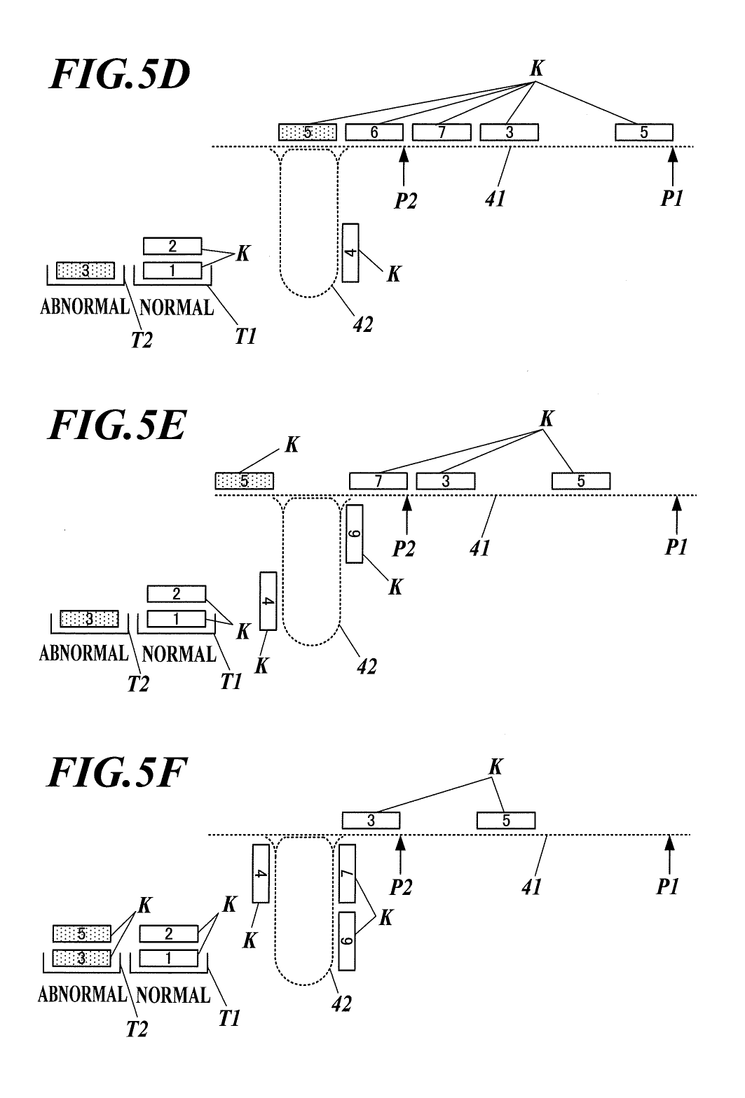

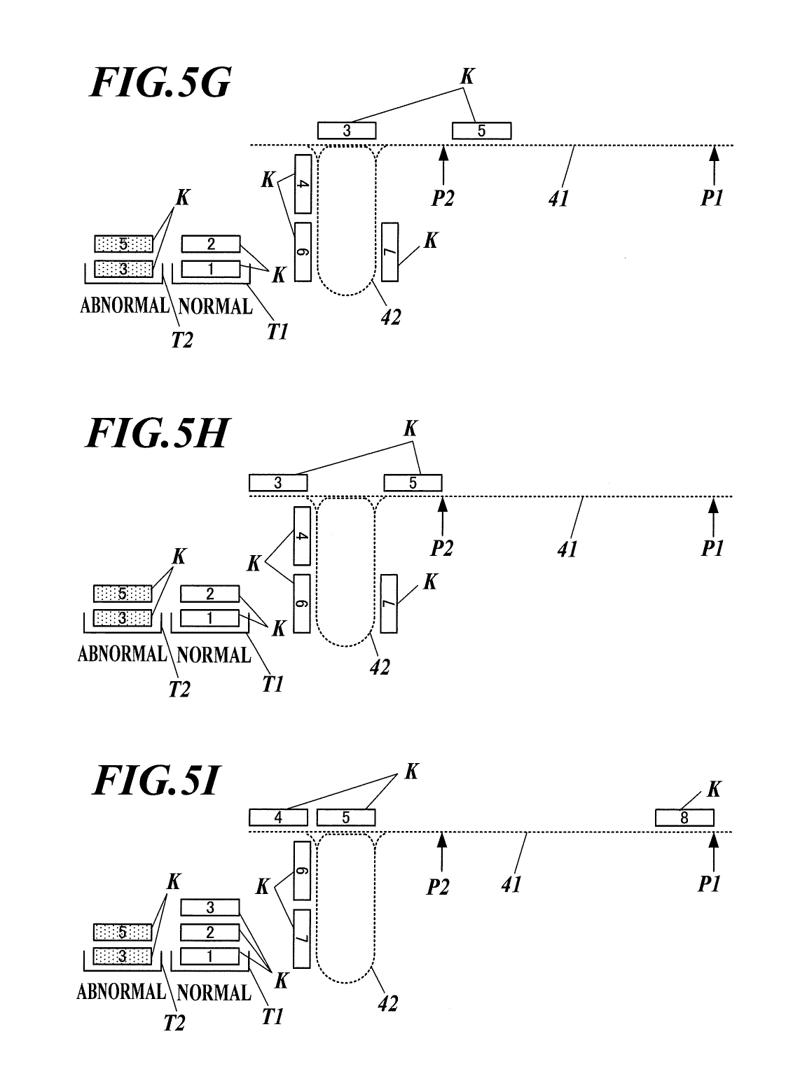

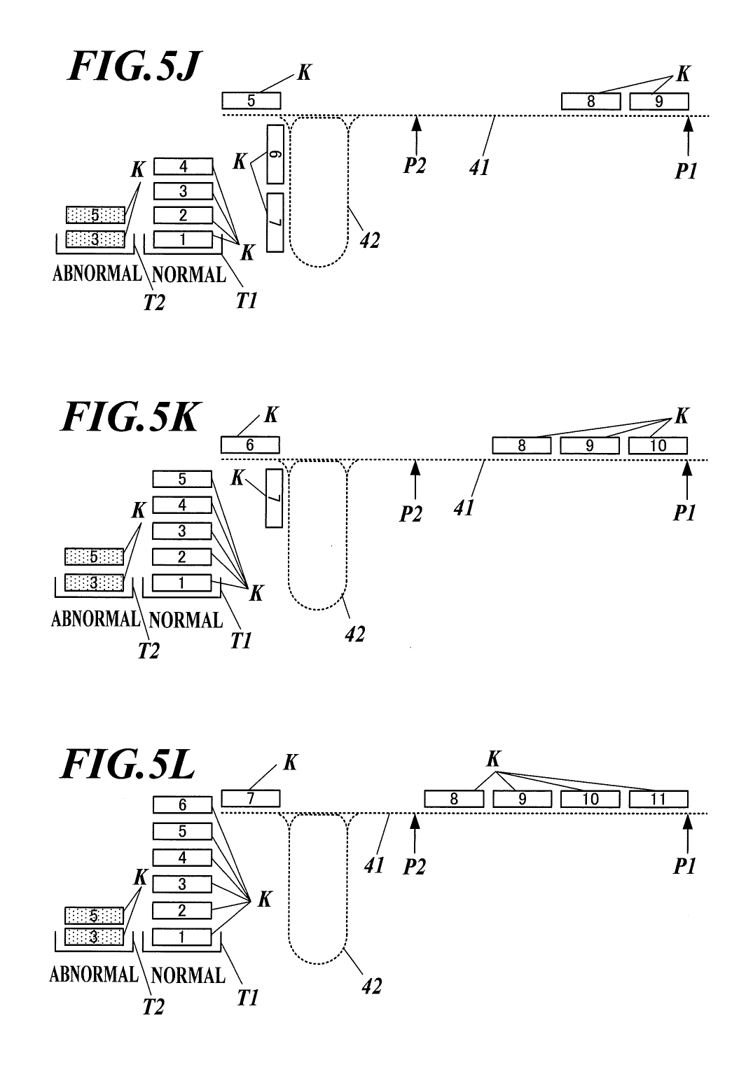

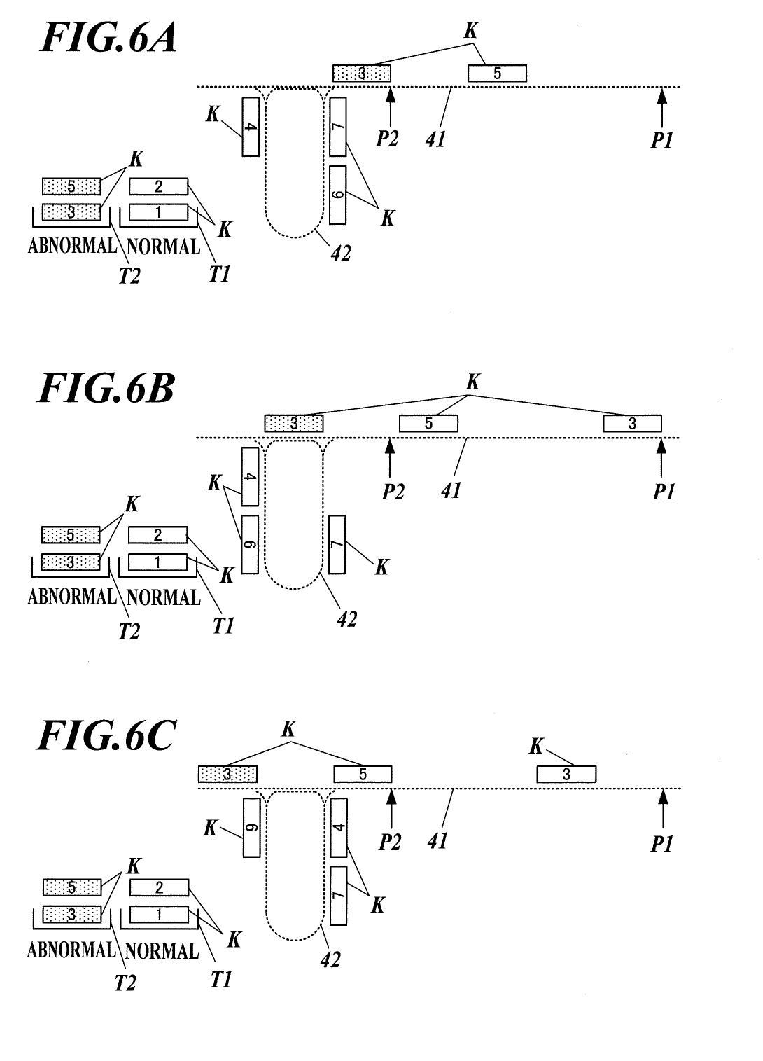

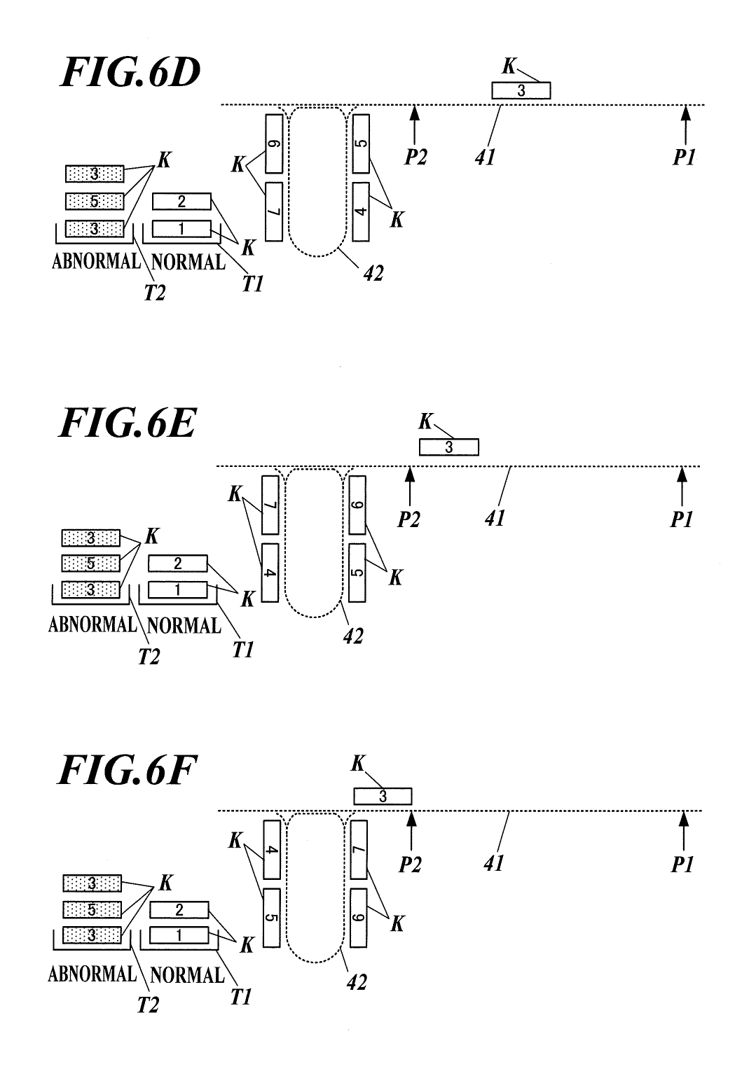

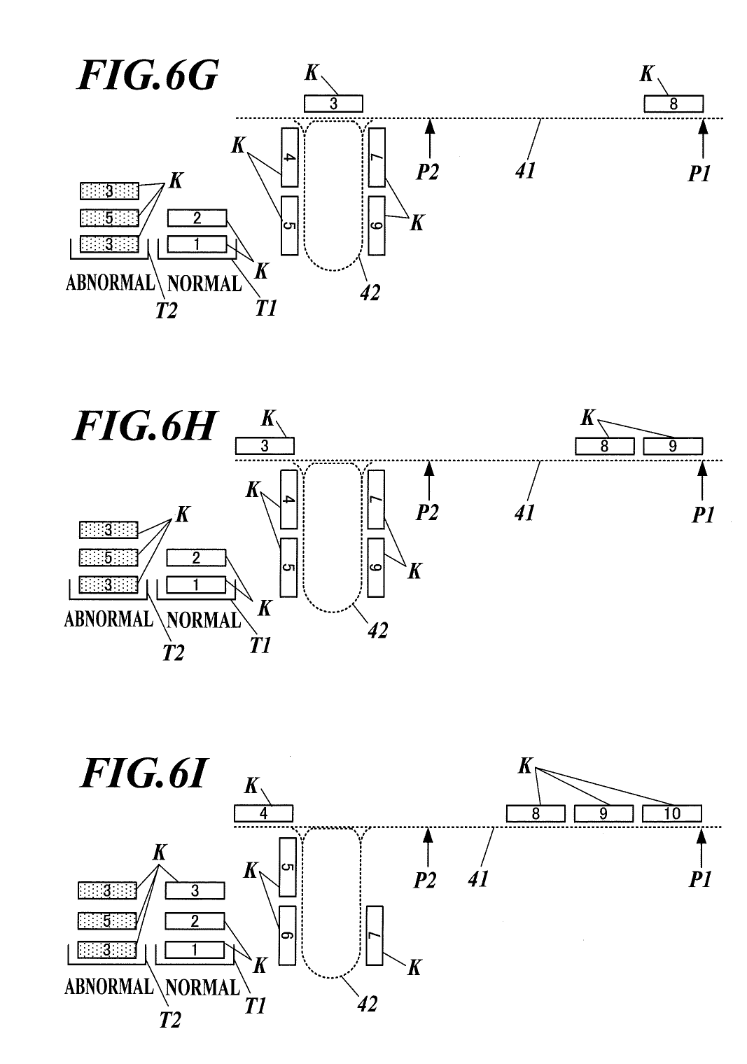

FIGS. 5A to 5L and FIGS. 6A to 6I show, in chronological order, the sheet conveyance flow in the unit 2 in the case where the images of the third and the fifth pages are intermittently determined as abnormal images.

In FIGS. 5A to 5L and FIGS. 6A to 6I, the numbers used for the individual sheets K indicate the page order. Further, the sheets K with dot pattern are the pages having images determined as abnormal images.

In FIGS. 5A to 5L and FIGS. 6A to 6I, the length of the first conveyance path 41 from the point P1 to the first tray T1 or the second tray T2 is equal to the path length on which seven pages of sheets K can be conveyed.

Further, the length of the first conveyance path 41 between the points P1 and P2 is equal to the path length on which four pages of sheets K can be conveyed, and the length of the second conveyance path 42 is longer than the path length between the points P1 and P2.

As shown in FIGS. 5A, 5B and 5C, the sheets K of the first and second pages having images determined as normal images are output to the first tray T1 via the first conveyance path 41 in the unit 2. Thereafter, if the image of the third page is determined as an abnormal image, the sheet of the third page is output to the second tray T2 via the first conveyance path 41 in the unit 2 as shown in FIGS. 5B, 5C and 5D.

In the unit 1, the image forming on a new page (the eighth page) is stopped at the time when the image of the third page is determined as an abnormal image and the image of the third page is reformed as shown in FIG. 5B.

In the unit 2, if the image of the fourth page is determined as a normal image as shown in FIG. 5B, the sheet of the fourth page is conveyed to the second conveyance path 42 as shown in FIG. 5C. Next, the sheet of the fifth page having image determined as an abnormal image is output to the second tray T2 via the first conveyance path 41 as shown in FIGS. 5D, 5E and 5F. In the unit 2, the sheets K of the sixth and seventh pages having images determined as normal images are conveyed to the second conveyance path 42 as shown in FIGS. 5E and 5F.

If the reformed image of the third page, which is reformed after the image of the seventh page is formed, is determined as a normal image as shown in FIG. 5F, the sheet of the third page on which the image is reformed is output to the first tray T1 via the first conveyance path 41 in the unit 2 as shown in FIG. 5G, 5H and 5I. After the sheet of the third page is output, the sheet K of the fourth page on the second conveyance path 42 is output to the first tray T1 as shown in FIGS. 5I and 5J.

If the reformed image of the fifth page, which is reformed after reforming the image of the third page, is determined as a normal image as shown in FIG. 5H, the sheet of the fifth page on which the image is reformed is output to the first tray T1 via the first conveyance path 41 in the unit 2 as shown in FIGS. 5I, 5J and 5K. After the sheet of the fifth page is output, the sheets of the sixth and seventh pages on the second conveyance path 42 are sequentially output to the first tray T1 as shown in FIGS. 5K and 5L. The sheet conveyance flow in the case where the images of the eighth page and the pages thereafter are determined as normal images is the same as the flow described in the image forming example 1 and thus, the description thereof is omitted.

In the above conveyance flow, if the reformed image of the third page, which is reformed after the image of the seventh page is formed, is determined as an abnormal image, the conveyance flow shown in FIG. 5F and thereafter is replaced by the conveyance flow shown in FIGS. 6A to 6I.

If the reformed image of the third page is determined as an abnormal image as shown in FIG. 6A, the sheet of the third page on which the image is reformed is output to the second tray T2 via the first conveyance path 41 in the unit 2 as shown in FIGS. 6B, 6C and 6D. In the unit 1, the image of the third page is reformed as shown in FIG. 6B.

If the reformed image of the fifth page, which is reformed after the image of the third page is reformed, is determined as a normal image as shown in FIG. 6C, the sheet of the fifth page on which the image is reformed is conveyed to the second conveyance path 42 in the unit 2 as shown in FIG. 6D.

In the unit 2, as shown in FIGS. 6D, 6E and 6F, the sheets K of the fourth to seventh pages on the second conveyance path 42 are made to be on standby by circulating on the second conveyance path 42 until the check result of the reformed image of the third page is obtained.

If the reformed image of the third page is determined as a normal image as shown in FIG. 6F, the sheet of the third page on which the image is reformed is output to the first tray T1 via the first conveyance path 41 in the unit 2 as shown in FIGS. 6G, 6H and 6I. In the unit 1, the image forming on new pages is restarted and the images of the eighth page and the pages thereafter are formed as shown in FIG. 6G.

After the sheet of the third page is output, the sheets K of the fourth to seventh pages on the second conveyance path 42 are output to the first tray T1 in the page order in the unit 2 as shown in FIG. 6I. The sheet conveyance flow in the case where the images of the eighth page and the pages thereafter are determined as normal images is the same as the sheet conveyance flow described in the image forming example 1 and thus, the description thereof is omitted.

In such way, even in the case where images of pages are intermittently determined as abnormal images, similarly to the case where images of pages are continuously determined as abnormal images, the sheets of the pages having images determined as normal images can be stacked in the page order on another tray which is different from the tray for stacking the sheets of the pages having images determined as abnormal images.

### IMAGE FORMING EXAMPLE 3

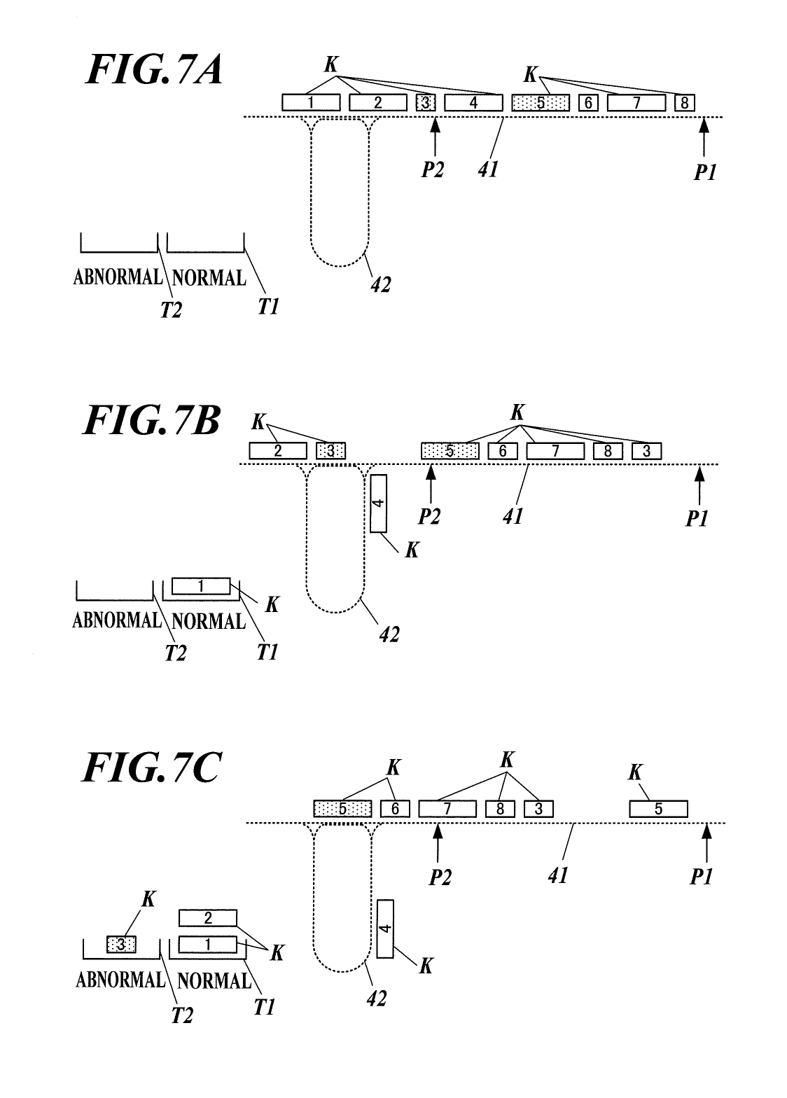

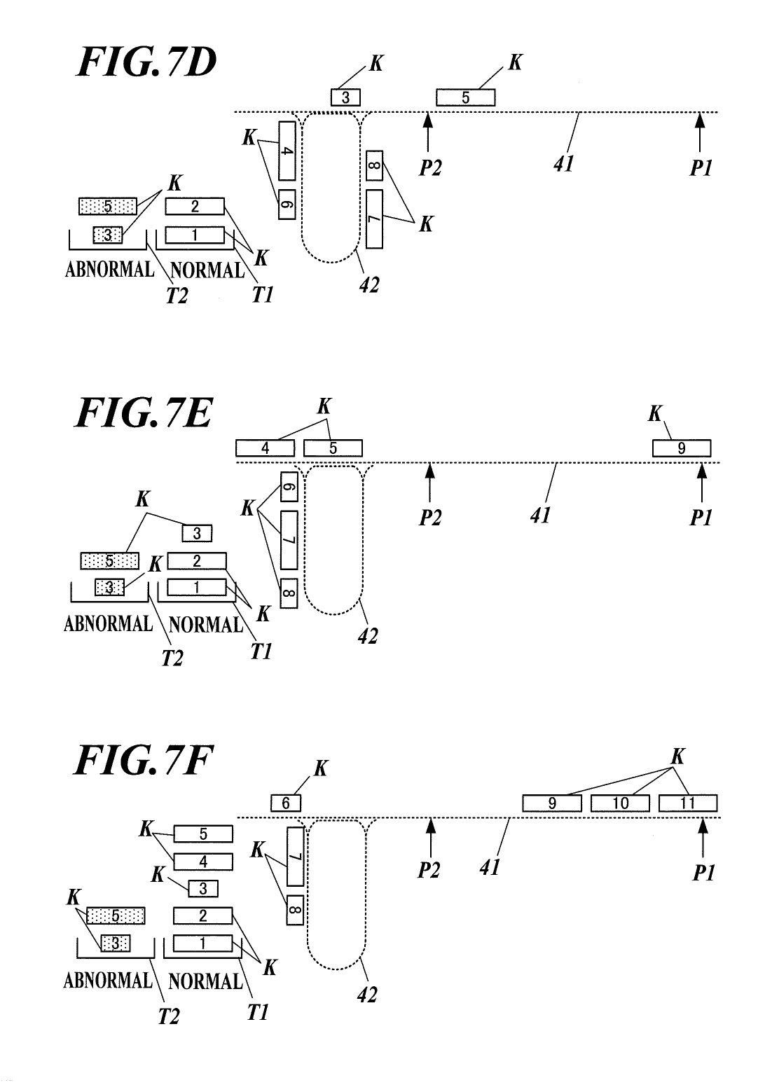

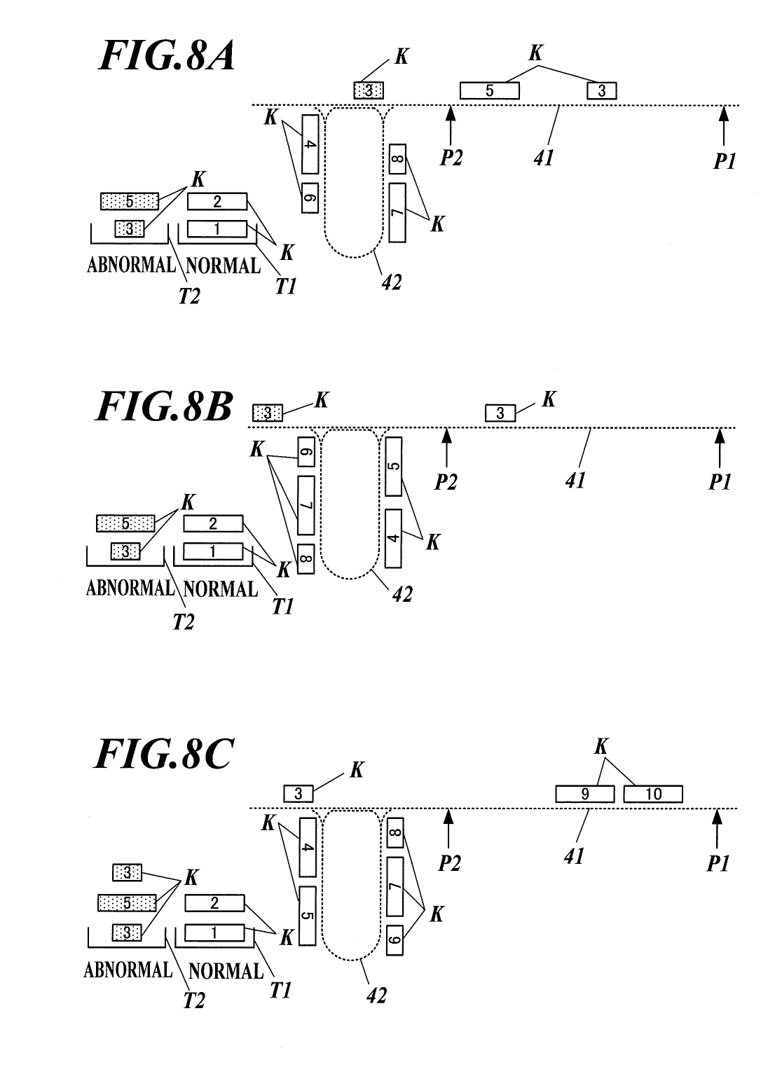

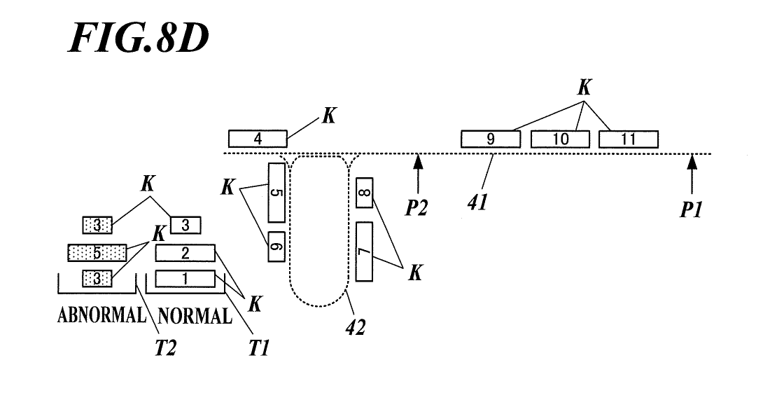

FIGS. 7A to 7F and FIGS. 8A to 8D show, in chronological order, the sheet conveyance flow in the unit 2 in the case where the images formed on the sheets of the third page and the fifth page are determined as abnormal images when the image forming is performed on sheets of two different sizes.

In FIGS. 7A to 7F and FIGS. 8A to 8D, the numbers used for the individual sheets K indicate the page order. Further, the sheets K with dot pattern are the pages having images determined as abnormal images.

With respect to the sheets K, there are sheets each having a large size in the conveyance direction and there are sheets each having a small size in the conveyance direction. The length in the conveyance direction of the small size sheet K is the half of the length in the conveyance direction of the large size sheet K.

In FIGS. 7A to 7F and FIGS. 8A to 8D, the length of the first conveyance path 41 from the point P1 to the first tray T1 or the second tray T2 is equal to the path length on which seven pages of small size sheets K can be conveyed.

The length of the first conveyance path 41 between the points P1 and P2 is equal to the path length on which four pages of large size sheets K can be conveyed, and the length of the second conveyance path 42 is longer than the path length between the points P1 and P2.

As shown in FIGS. 7A, 7B and 7C, the sheets K of the first and second pages having images determined as normal images are output to the first tray T1 via the first conveyance path 41 in the unit 2. Thereafter, if the image of the third page is determined as an abnormal image, the sheet of the third page is output to the second tray T2 via the first conveyance path 41 in the unit 2 as shown in FIGS. 7B and 7C.

In the unit 1, the image forming on a new page (the ninth page) is stopped at the time when the image of the third page is determined as an abnormal image and the image of the third page is reformed as shown in FIG. 7B.

If the image of the fourth page is determined as a normal image, the sheet K of the fourth page is conveyed to the second conveyance path 42 in the unit 2 as shown in FIG. 7B. Next, if the image of the fifth page is determined as an abnormal image, the sheet of the fifth page is output to the second tray T2 via the first conveyance path 41 as shown in FIGS. 7C and 7D.

Further, if the images of the sixth to eighth pages are determined as normal images, the sheets of the sixth to eighth pages are sequentially output to the second conveyance path 42 in the unit 2 as shown in FIG. 7D.

If the reformed image of the third page, which is reformed after the image of the eighth page is formed, is determined as a normal image, the sheet of the third page is output to the first tray T1 via the first conveyance path 41 in the unit 2 as shown in FIGS. 7D and 7E. After the sheet of the third page is output, the sheet of the fourth page on the second conveyance path 42 is output to the first tray T1 as shown in FIGS. 7E and 7F.

If the reformed image of the fifth page, which is reformed after the image of the third page is reformed, is determined as a normal image, the sheet of the fifth page on which the image is reformed is output to the first tray T1 via the first conveyance path 41 in the unit 2 as shown in FIGS. 7E and 7F. After the sheet of the fifth page is output, the sheets K of the sixth to eighth pages on the second conveyance path 42 are output to the first tray T1 in the page order as shown in FIG. 7F.

In the above conveyance flow, if the reformed image of the third page, which is reformed after the image of the eighth page is formed, is determined as an abnormal image, the conveyance flow shown in FIG. 7D and thereafter is replaced by the conveyance flow shown in FIGS. 8A to 8D.

If the reformed image of the third page is determined as an abnormal image as shown in FIG. 8A, the sheet K of the third page is output to the second tray T2 via the first conveyance path 41 in the unit 2 as shown in FIGS. 8A, 8B and 8C. In the unit 1, the image of the third page is reformed as shown in FIG. 8A.

If the reformed image of the fifth page, which is reformed after the image of the third page is determined as an abnormal image, is determined as a normal image, the sheet of the fifth page on which the image is reformed is output to the second conveyance path 42 in the unit 2 as shown in FIGS. 8A and 8B.

In the unit 2, as shown in FIGS. 8A and 8B, the sheets K of the fourth to eighth pages on the second conveyance path 42 are made to be on standby by circulating on the second conveyance path 42 until the check result of the third page having image reformed after the image of the fifth page is reformed is obtained.

Thereafter, if the reformed image of the third page, which is reformed after the image of the fifth page is reformed, is determined as a normal image, the sheet K of the third page is output to the first tray T1 via the first conveyance path 41 in the unit 2 as shown in FIGS. 8C and 8D. In the unit 1, the image forming on new pages is restarted and the images of the ninth page and the pages thereafter are formed as shown in FIG. 8C.

In the unit 2, after the sheet of the third page is output, the sheets K of the fourth to eighth pages on the second conveyance path 42 are output to the first tray T1 in the page order as shown in FIG. 8D. The sheet conveyance flow in the case where the images of the ninth page and the pages thereafter are determined as normal image is the same as the conveyance flow described in the image forming example 1 and thus, the description thereon is omitted.

In such way, even in the case where images are formed on sheets of different sizes, similarly to the case where the sheets are in the same size, the sheets of the pages having images determined as normal images can be stacked in the page order on another tray which is different from the tray for stacking the sheets of the pages having images determined as abnormal images.

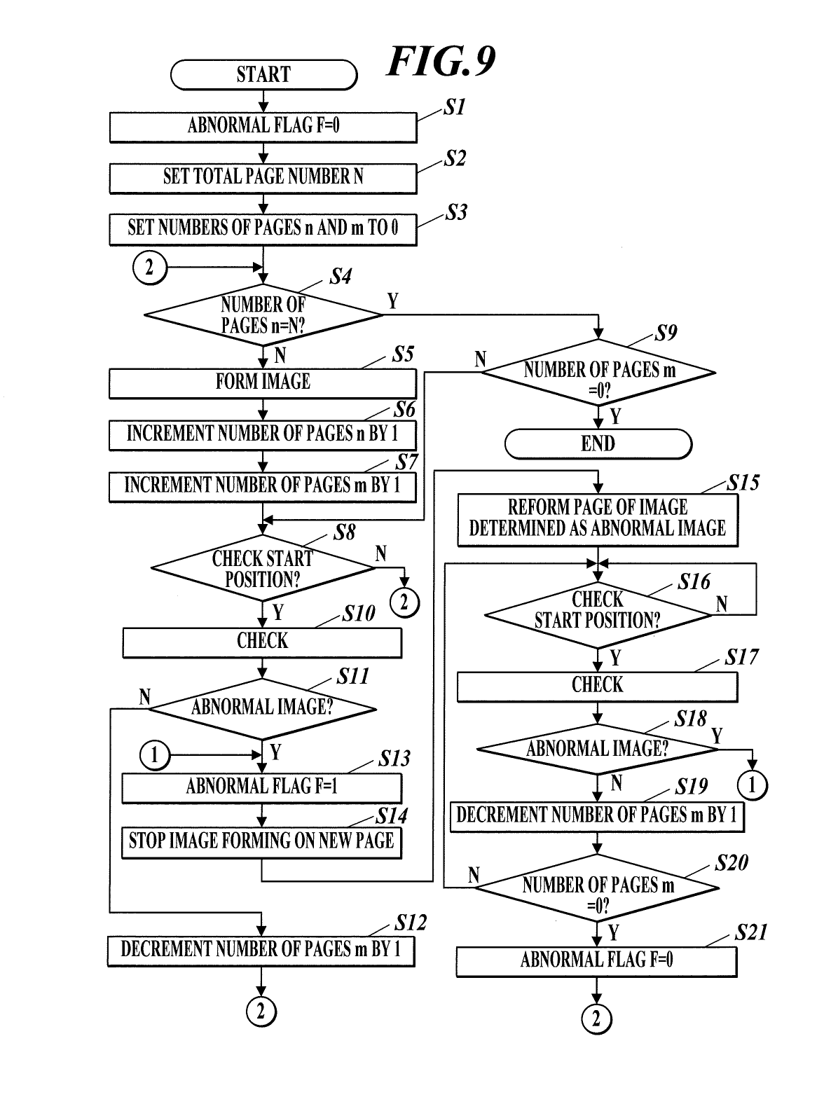

FIG. 9 shows the process procedure in the image forming system G when forming images as described in the image forming examples 1 to 3.

As shown in FIG. 9, in the image forming system G, the controller 33 of the unit 2 sets the abnormal flag F to 0 (step S1). If the abnormal flag F is set to 0, this means that an image is determined as an abnormal image after checking and that there is a page which requires recovery. Recovery means to repeat reforming an image until the image is determined as a normal image.

On the other hand, the controller 11 of the unit 1 sets the total page number N on which images are to be formed (step S2). The controller 11 further sets the number of pages n having images already formed and the number of pages m which remain on the conveyance path behind the point (point P1 in the image forming examples 1 to 3) where the image forming ends to the initial values of 0 (step S3).

In the case where the images of all of the pages are not yet formed and the number of pages n has not yet reached the total page number N (step S4: N), the image forming unit 20 forms an image on a sheet of one page (step S5).

If an image is formed by the image forming unit 20, the controller 11 increments the number of pages n, which indicates the number of pages having images already formed, by 1 (step S6). Since the number of sheets of pages on the conveyance path is increased by one due to the image forming, the controller 11 also increments the number of pages m, which indicates the number of pages on the conveyance path, by 1 (step S7).

If a sheet of a page having image already formed has not yet reached the check start position where the sheet is to be read in the unit 2 (step S8: N) and if the number of pages n which is incremented has not yet reached the total page number N (step S4: N), the processes of the above steps S5 to S7 are repeated to form an image on the sheet of the next page.

In the case where the number of pages n reached the total page number N by being incremented (step S4: Y), if the number of pages m on the conveyance path is 0 (step S9: Y), this means that all of the sheets on the conveyance path in the unit 2 are output and that the images of all of the pages are formed in the normal manner and thus, the process ends. On the other hand, if the number of pages m on the conveyance path is not 0 (step S9: N), this means that there are sheets remaining on the conveyance path without being output according to the check result and thus, the process proceeds to step S8.

If a sheet of a page on which an image is already formed reaches the check start position (step S8: Y), the image reading unit 31 reads the sheet surface of the page and generates read image data. The check unit 32 uses the read image data which is generated by the image reading unit 31 to execute checking of the image (step S10).

As a result of checking, if the image is determined as a normal image (step S11: N), the sheet having image determined as a normal image is output to the first tray T1 and is no longer on the conveyance path, thus, the controller 11 decrements the number of pages m on the conveyance path by 1 (step S12). Thereafter, the process returns to step S4. If the number of pages n has not yet reached the total page number N, the process continues with the image forming on new pages.

As a result of checking, if an image is determined as an abnormal image (step S11: Y), the controller 33 sets the abnormal flag F to 1 (step S13). Setting the abnormal flag F to 1 indicates that an image is determined as an abnormal image and that there is a page which requires recovery.

In the unit 1, in accordance with the abnormal flag F being set to 1, the image forming on a new page by the image forming unit 20 is stopped (step S14) and the image of the page which is determined as an abnormal image is reformed (step S15).

Thereafter, if the sheet of the page which comes after the page having image determined as an abnormal image reaches the check start position (step S16: Y), the image reading unit 31 reads the sheet surface of the page and generates read image data. The check unit 32 uses the read image data which is generated by the image reading unit 31 to execute checking of the image (step S17).

As a result of checking, if the image of the later page is also determined as an abnormal image (step S18: Y), the process returns to step S13 and the image of the page which is determined as an abnormal image is to be reformed.

As a result of checking, if the image of the later page is determined as a normal image (step S18: N), the sheet having image is determined as a normal image is output to the first tray T1 and is no longer on the conveyance path, thus, the controller 11 decrements the number of pages m on the conveyance path by 1 (step S19).

If the number of pages m after being decremented has not yet reached 0 (step S20: N), this means that the later pages are remained on the conveyance path without being output according to the check result and thus, the process returns to step S16 and reforms the images of the later pages which are determined as abnormal images if there are any.

If the number of pages m on the conveyance path reaches 0 by being decremented (step S20: Y), this means that the images of all of the pages which are already formed are determined as normal images and that the sheets of the pages are output to the first tray T1 and thus, the controller 33 sets the abnormal flag F to 0 (step S21). Thereafter, the process returns to step S4 and restarts the image forming on new pages.

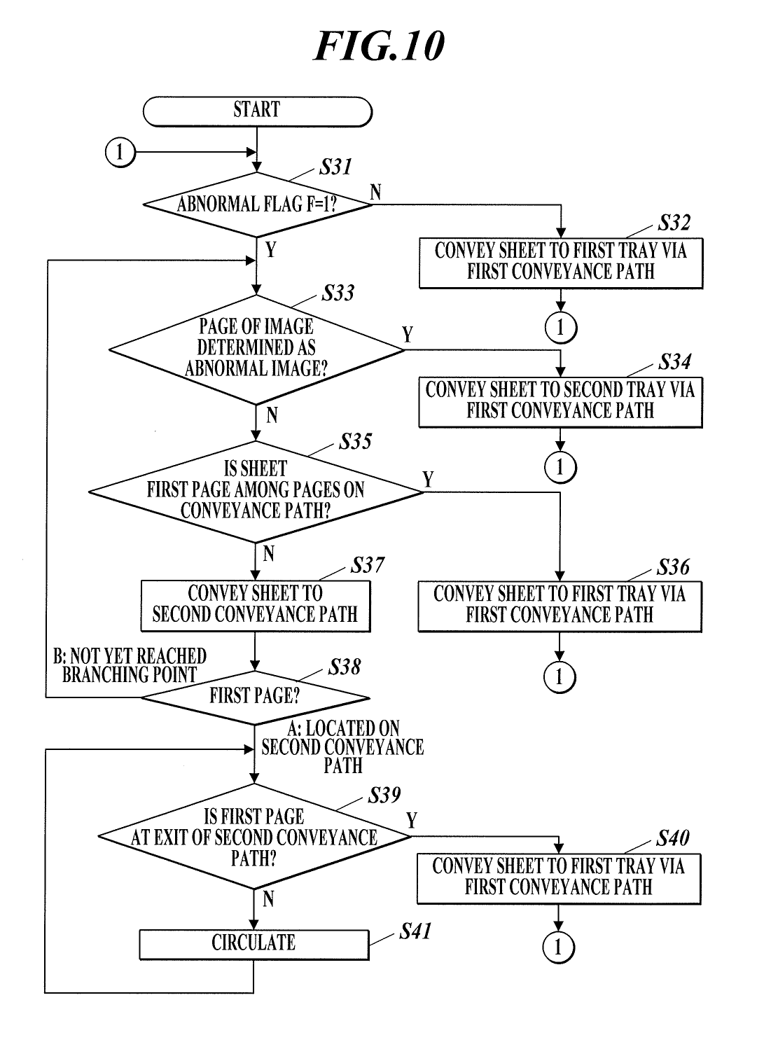

FIG. 10 shows the process procedure in the image forming system G when sheets on which images are already formed in the unit 2 are to be conveyed.

When a sheet on which an image is formed in the unit 1 is conveyed to the unit 2 and reaches the branching point to the first conveyance path 41 or to the second conveyance path 42, the controller 33 checks the abnormal flag F in the unit 2. As described above, the abnormal flag F is set to 0 when there is no page having image determined as abnormal image on the conveyance path in the unit 2. Therefore, as shown in FIG. 10, if the abnormal flag F is set to 0 (step S31: N), the sheet which reached the branching point is the sheet of the page having image determined as a normal image. Thus, the sheet of the page is output to the first tray T1 via the first conveyance path 41 by the conveyance mechanism 40 in the unit 2 (step S32).

On the other hand, if the abnormal flag F is set to 1 (step S31: Y), the sheet which reached the branching point to the first conveyance path 41 or to the second conveyance path 42 is the sheet of the page that comes after the page having image determined as an abnormal image. If the sheet which reached the branching point is the sheet of the page having image determined as an abnormal image (step S33: Y), the sheet of the page is conveyed to the second tray T2 via the conveyance path 41 by the conveyance mechanism 40 (step S34).

If the sheet which reached the branching point is the sheet of the page having image determined as a normal image (step S33: N) and is the sheet of the page that comes first in the page order among all the sheets of the pages on the conveyance path in the unit 2 (step S35: Y), the sheet of this page is conveyed to the first tray T1 via the first conveyance path 41 (step S36).

After the sheet is conveyed to the first tray T1 or the second tray T2, the process returns to step S31 and conveys the next page which reaches the branching point.

If the sheet which reached the branching point is the sheet of the page having image determined as a normal image (step S33: N) and is not the sheet of the page that comes first in the page order among all the sheets of the pages on the conveyance path in the unit 2 (step S35: N), the sheet of the page which reached the branching point is conveyed to the second conveyance path 42 (step S37).

After the sheet of the page which reached the branching point is conveyed to the second conveyance path 42, if the sheet of the page that comes first in the page order, among the pages on the second conveyance path 42 and the pages which have not yet reached the branching point, has not yet reached the branching point (step S38: B), the process returns to step S33 and conveys the next page which reaches the branching point.

On the other hand, if the sheet of the page that comes first in the page order is on the second conveyance path 42 (step S38: A) and if the sheet of the page that comes first in the page order is at the exit of the second conveyance path 42 (step S39: Y), the sheet of the page that comes first in the page order is output to the first tray T1 from the second conveyance path 42 (step S40). Thereafter, the process returns to step S31 and conveys the next page which reaches the branching point.

If the sheet of the page that comes first in the page order is not at the exit of the second conveyance path 42 (step S39: N), the sheets of the pages on the second conveyance path 42 are made to circulate in the second conveyance path 42 repeatedly by the conveyance mechanism 40 until the sheet of the page that comes first in the page order be at the exit of the second conveyance path 42 (step S41). If the sheet of the page that comes first in the page order reaches the exit of the second conveyance path 42 (step S39: Y), the sheet of the page that comes first in the page order is conveyed and output to the first tray T1 from the second conveyance path 42 (step S40). For example, as a result of conveying the sheet of the fourth page to the second conveyance path 42, if the sheets of the fifth, sixth, seventh and fourth pages are lined in this order from the position near the exit of the second conveyance path 42, the sheets on the second conveyance path 42 are made to circulate and when the sheet of the fourth page reaches the exit of the second conveyance path 42, this sheet is output. Thereafter, the sheets on the second conveyance path 42 are made to further circulate and when the sheets of the fifth, sixth and seventh pages reach the exit of the second conveyance path 42, these sheets are output.

Thereafter, the process returns to step S31 and conveys the next page which reached the branching point.

In the above process procedure, when the sheets are to be output to the first tray T1 from the second conveyance path 42, the sheets are made to circulate on the second conveyance path 42 so that the sheets are to be output in the page order. However, the sheets on the second conveyance path 42 may be made to circulate when conveying the sheets to the second conveyance path 42. That is, the conveyance mechanism 40 makes the sheets of the pages on the second conveyance path 42 circulate and makes the sheets which are already on the second conveyance path 42 and the sheets which are newly conveyed to the second conveyance path 42 be lined in the page order on the second conveyance path 42.

For example, in the case where the sheet of the fourth page is to be conveyed on to the second conveyance path 42 where the sheets of the fifth to seventh pages already exist, if the sheet of the fourth page falls in the position between the sheets of the sixth and seventh pages, the sheets of the fifth to seventh pages are made to circulate on the second conveyance path 42 so that the sheet of the fourth page be at the position after the sheet of the seventh page and before the sheet of the fifth page on the second conveyance path 42 and then, the sheet of the fourth page is conveyed.

Further, the conveyance mechanism 40 may make the sheets which are conveyed on to the second conveyance path 42 circulate in the second conveyance path 42 all the time and may stop the circulation when the sheet of the page that comes first in the page order among the sheets on the second conveyance path 42 reaches the exit of the second conveyance path 42.

In such way, when outputting the sheets on the second conveyance path 42 to the first tray T1, the sheets can be output in an order starting from the sheet of the page that comes first in the page order in the second conveyance path 42 and thus, output can be carried out smoothly.

As described above, the image forming system G of the embodiment includes the image forming unit 20 which forms images on sheets of a plurality of pages, the check unit 32 which determines whether the image of each page formed by the image forming unit 20 is a normal image or an abnormal image, and the conveyance mechanism 40 which conveys a sheet of a page having image determined as a normal image by the check unit 32 to the first tray T1 via the first conveyance path 41 and which conveys a sheet of a page having image determined as an abnormal image to the second tray T2 via the first conveyance path 41. If an image of a page is determined as an abnormal image by the check unit 32, the image forming unit 20 stops the image forming on a new page and reforms the image of the page which is determined as an abnormal image. The conveyance mechanism 40 includes the second conveyance path 42 which is a detour path of the first conveyance path 41 and has a length which is at least the same as the path length from the point where the image forming by the image forming unit 20 ends to the point where the determination result of the check unit 32 is obtained. Among the pages which come after the one page having image determined as an abnormal image and the pages having images already formed by the time the image of the one page is determined as an abnormal image, the conveyance mechanism 40 conveys the sheets of the pages having images determined as abnormal images by the check unit 32 to the second tray T2 via the first conveyance path 41 and conveys the sheets of the pages having images determined as normal images by the check unit 32 to the second conveyance path 42 and make the sheets be on standby. Thereafter, the conveyance mechanism 40 conveys the sheets of the pages having reformed images determined as normal images and the sheets of the pages on the second conveyance path 42 to the first tray T1 in the page order.

According to the image forming system G, until the image of the page which is determined as an abnormal image is reformed and the reformed image is determined as a normal image and the sheet on which the image is reformed is output to the first tray T1 which is for the normal images, the sheets of the pages having images determined as normal images that come after the above page having image determined as an abnormal image can be made to be on standby on the second conveyance path 42. Since the image forming on new pages is stopped at the time when an image is determined as an abnormal image and since the length of the second conveyance path 42 is longer than the path length from the point where the image forming ends to at least the point where the check result is obtained, all of the sheets of the pages having images already formed by the time when the image is determined as an abnormal image can be held on the second conveyance path 42.

By having a simple structure of including one second conveyance path 42, the sheets of the pages having images determined as normal images can be stacked in the page order.

In the above embodiment, since the second conveyance path 42 is a circulation path, the conveyance mechanism 40 can make the sheets of the pages on the second conveyance path 42 be on standby by circulating on the second conveyance path 42 until the sheets of the pages having reformed images determined as normal images are to be output to the first tray T1.

The second conveyance path 42 is a circulation path, and in a case where a sheet of a page which comes first in the page order is located at an exit of the second conveyance path 42, the conveyance mechanism 40 conveys the sheet of the page which comes first in the page order to the first tray T1, and in a case where the sheet of the page which comes first in the page order is not located at the exit of the second conveyance path 42, the conveyance mechanism 40 can make the sheet of each page on the second conveyance path 42 circulate in the second conveyance path 42 until the sheet of the page which comes first in the page order is located at the exit of the second conveyance path 42.

Further, if an image of a page which is determined as an abnormal image is reformed and the reformed image is determined as a normal image by the check unit 32, the image forming unit 20 restarts the image forming on a new page.

In such way, images can be formed on the sheets of all of the pages while carrying out recovery of each page every time an image is determined as an abnormal image.

The above embodiments are preferred examples of the present invention and they do not limit the present invention in any way. The present invention can be modified within the scope of the invention.

For example, as for the computer readable medium to store the programs which can be read by the controllers 11 and 33, non-volatile memories such as a ROM, a flash memory and the like and portable recording mediums such as a CD-ROM and the like can be used. Further, as the medium for providing program data via a communication circuit, a carrier wave can also be used.

The entire disclosure of Japanese Patent Application No. 2015-184583 filed on Sep. 18, 2015 including description, claims, drawings, and abstract are incorporated herein by reference in its entirety.

What is claimed is:

1. An image forming system, comprising:
an image forming unit which forms images on sheets of a plurality of pages;
a check unit which determines whether an image of each page formed by the image forming unit is a normal image or an abnormal image; and
a conveyance mechanism which conveys a sheet of a page having an image determined as the normal image by the check unit to a first tray via a first conveyance path and which conveys a sheet of a page having an image determined as the abnormal image by the check unit to a second tray via the first conveyance path; wherein
when an image of a page is determined as the abnormal image by the check unit, the image forming unit stops image forming on a sheet of a new page and reforms the image of the page which is determined as the abnormal image,
the conveyance mechanism includes a second conveyance path which is a detour path of the first conveyance path and has a length that is at least equal to a path length from a point where the image forming by the image forming unit ends to a point where a determination result of the check unit is obtained, and
among pages which come after the page having the image determined as the abnormal image and have images already formed when the image is determined as the abnormal image, the conveyance mechanism conveys a sheet of a page having an image determined as the abnormal image to the second tray via the first conveyance path and conveys a sheet of each page having an image determined as the normal image to the second conveyance path so as to be on standby, and the conveyance mechanism conveys a sheet of a page having a reformed image determined as the normal image and the sheet of each page on the second conveyance path to the first tray in a page order.

2. The image forming system of claim 1, wherein
the second conveyance path is a circulation path, and
the conveyance mechanism makes the sheet of each page on the second conveyance path circulate in the second conveyance path so as to be on standby until the conveyance mechanism conveys the sheet of the page having the reformed image determined as the normal image to the first tray.

3. The image forming system of claim 1, wherein
the second conveyance path is a circulation path, and
in a case where a sheet of a page which comes first in the page order is located at an exit of the second conveyance path, the conveyance mechanism conveys the sheet of the page which comes first in the page order to the first tray, and in a case where the sheet of the page which comes first in the page order is not located at the exit of the second conveyance path, the conveyance mechanism makes the sheet of each page on the second conveyance path circulate in the second conveyance path until the sheet of the page which comes first in the page order is located at the exit of the second conveyance path.

4. The image forming system of claim 1, wherein in a case where the image of the page which is determined as the abnormal image is reformed and the reformed image is determined as the normal image by the check unit, the image forming unit restarts the image forming on the sheet of the new page.

5. An image forming method, comprising:
forming images on sheets of a plurality of pages with an image forming unit;
determining whether an image of each page formed by the image forming unit is a normal image or an abnormal image with a check unit;
conveying, with a conveyance mechanism, a sheet of a page which has an image determined as the normal image by the check unit to a first tray via a first conveyance path and conveying a sheet of a page which has an image determined as the abnormal image by the check unit to a second tray via the first conveyance path;
stopping image forming on a sheet of a new page by the image forming unit and reforming an image of a page which is determined as the abnormal image when the image of the page is determined as the abnormal image by the check unit;
among pages which come after the page having the image determined as the abnormal image and have images already formed when the image is determined as the abnormal image, conveying, with the conveyance mechanism, a sheet of a page having an image determined as the abnormal image to the second tray via the first conveyance path and conveying a sheet of each page having an image determined as the normal image to a second conveyance path so as to be on standby, the second conveyance path being a detour path of the first conveyance path and having a length which is at least equal to a path length from a point where the image forming by the image forming unit ends to a point where a determination result of the check unit is obtained; and
conveying a sheet of a page which has a reformed image determined as the normal image and the sheet of each page on the second conveyance path to the first tray in a page order.
